(19) United States
(12) Patent Application Publication
(10) Pub. No.: US 2004/0049134 A1
(43) Pub. Date: Mar. 11, 2004

(54) System and methods for treatment of alzheimer's and other deposition-related disorders of the brain

(76) Inventors: Carol A. Tosaya, Los Altos, CA (US); John W. Sliwa JR., Los Altos, CA (US)

Correspondence Address: David W. Collins - Intellectual Property Law, Suite 125B, 75 Calle de las Tiendas, Green Valley, AZ, 85614, US

(21) Appl. No.: 10/612,171

(22) Filed: Jul. 1, 2003

Related U.S. Application Data
(60) Provisional application No. 60/394,089, filed on Jul. 2, 2002.

(51) Int. Cl. A61H 1/00

(52) U.S. Cl. 601/2

(57) ABSTRACT

A system and methods are provided for the therapeutic treatment of brain-plaques, fibrils, abnormal-protein related or aggregation-prone protein related deposition-diseases. The system employs acoustic exposure therapy means for delivering therapeutic energy to at least one brain region. The therapy supports at least one of the following processes: (i) physical breakup, erosion, disentanglement, de-aggregation, dissolution, de-agglomeration, de-amalgamation or permeation of the deposits, (ii) interference in at least one deposit formation process, deposition related chemical reaction or biological or genetic pathway contributing to the deposits or deposition-related processes, and (iii) aiding the recovery, growth, regrowth or improved functionality of brain-related cells or functional pathways negatively impacted by, stressed by or disposed to the deposits, deposition-processes or deposition disease state, or supporting the growth of newly transplanted cells anywhere in the brain-related anatomy. The system and methods treat Alzheimer's and other deposition-related disorders of the brain, with minimal adverse side effects to the patient and may be used in cooperation with a drug.

### CROSS-REFERENCE TO RELATED APPLICATION

The present application claims priority from provisional application Serial No. 60/394,089, filed Jul. 2, 2002.

### TECHNICAL FIELD

The present invention relates generally to the treatment of deposition-related disorders of the brain, such as Alzheimer's disease, and, more particularly, to brain diseases characterized by the deposition of plaques, fibrils, fibril tangles, micronodules or abnormal protein materials.

### BACKGROUND ART

Introduction

There are many neurodegenerative diseases in humans, which are marked by the undesirable deposition of plaques, fibril tangles, micronodular or diffuse deposits in the brain. These plaques or deposits frequently consist of aggregation-prone abnormal proteins, some of which are shown in Table I below with their associated diseases and suspected genetic associations. The deposition of these materials, whether the cause or just a symptom of diseases such as Alzheimer's disease (AD), is not yet clearly understood. What is known is that the extent of certain of these depositions correlates well with functional losses such as cognitive and memory losses or motor losses. In the particular case of Alzheimer's (AD), the Alzheimer's Association reports that over 4 million Americans currently have AD and that 14 million will have it by 2050. By 2025, at least 22 million people worldwide will have AD. One in 10 elder Americans is expected to get AD and most of them will die of the disease in 3 to 5 years. Alzheimer's costs the US at least $100 billion per year now and that is expected to rise rapidly with newly announced federal coverage and further federal R&D investments beyond the current federal R&D level of $480 million dollars per year. The Alzheimer's Association itself has already invested over $100 million dollars in AD R&D. In the disease histology section below, we list a number of other deposition-related diseases that exhibit deposits of these general types and could utilize the invention herein. We stress that although we focus on Alzheimer's Disease herein, our invention is fully applicable to any disease exhibiting such deposition processes or anticipated deposition-processes.

TABLE I
Features of Neuorodegenerative Disorders Characterized by Aggregation
and Deposition of Abnormal Protein.

| | Protein | | Disease | |
|---|---|---|---|---|
| Disease | Deposits | Toxic Protein | Genes | Risk Factor |
| Alzheimer's | Extracellular | Aβ | APP* | apoE4 allele |
| | plaques | | Presenilin 1§ | |
| | | | Presenilin 2§ | |
| | Intracellular | tau | | |
| | tangles | | | |
| Parkinson's | Lewy bodies | α-Synuclein | α- | tau linkage |
| | | | Synuclein* | |
| | | | Parkin§ | |
| | | | UCHL1§ | |
| Prion | Prion plaque | PrP^{5c} | PRNP* | Homozy- |
| | | | | gosity at |
| | | | | prion codon |
| | | | | 129 |
| Poly- | Nuclear and | Polyglutamine- | 9 different | |
| glutamine | cytoplasmic | containing | genes with | |
| | inclusions | proteins | CAG repeat | |
| | | | expansion* | |
| Tauopathy | Cytoplasmic | tau | tau* | tau linkage |
| | tangles | | | |
| Familial | Bunina | SOD1 | SOD1* | |
| amyotrophic | bodies | | | |
| lateral | | | | |
| sclerosis | | | | |

Notes:
*Pathogenic mutations are associated with a toxic gain of function.
§Pathogenic mutations are associated with a loss of function.

Table I is taken from “Toxic Proteins in Neurodegenerative Disease” by J. Paul Taylor et al, Science Magazine, Vol. 296, pp. 1991-1995 (Jun. 14, 2002).

More than 7 of 10 Alzheimer's patients live at home and their care is a huge psychological and financial challenge to their caretakers. Lost work time by caretakers is another cost to our economy. As AD progresses, the level of care increases until the patient cannot perform basic bodily functions without help and oversight.

Alzheimer's attacks both the hippocampus and the cerebral cortex. Early-stage damage is usually found in the pCC or posterior cingulated cortex and the entorhinal cortex as well as the hippocampus. Memory is particularly affected by the hippocampus damage and learning and reasoning are particularly affected by the cerebral cortex damage.

At this time, there are no cures and no established AD diagnostics, which can be purchased by or prescribed to the consumer. There are a couple of drugs that seem to slow the inevitable process, but do not stop it. There are numerous further investigations underway, including clinical trials, to understand how to identify AD early and then how to slow, stop or preferably reverse the damage done by AD. At present, there are no devices specifically designed or arranged to treat AD or AD-related processes other than the experimental Eunoe Inc. CSF drainage shunt discussed in the accompanying Information Disclosure Statement. Virtually all current efforts to identify and/or cure AD involve (a) imaging devices for directly imaging AD plaques/tangles, (b) lab-tests which can identify AD or potential for AD early-on via blood or spinal fluid samples or to measure disease progress in sick patients, (c) therapeutic drugs of many types for treating AD, (d) controlled diets or control of dietary ingested matter or content, and (e) the development of AD animal models for use in drug/therapy testing.

The present inventors undertook to review potentially relevant art and publications in fields that could have a bearing on the AD challenge. Such fields include those of AD histology, AD plaque properties, AD drug therapy, the general subject of plaques in the human body and how they have been dealt with, the technology of delivering drugs and therapeutic energies into the brain and the interaction of ultrasound with the brain and with contrast agents. We also looked at the simple fact that given millions of AD patients, any therapy must be as inexpensive and productive as possible in terms of the financial stress it puts on our medical and family infrastructures. In other words, although a multimillion dollar piece of capital equipment may eventually provide a solution, if that equipment can provide therapy to only a handful of patients a day, then we still have a huge financial burden as many, many such machines would be required, particularly if multiple therapies are scheduled for each patient over an extended period.

It will be seen from the next sections that it is likely a therapeutic drug will be involved in an optimal AD therapy or cure even if a device is also employed. This is because devices and drugs can produce symbiotic effects beyond merely additive effects. For example a drug could presoften deposits such that ultrasound can more easily dissolve them. The present inventors will thereafter disclose a preferred combined drug/device combination which promises the low-cost high-throughput solution that is needed for AD and related diseases. The inventive device, if necessary, can also offer therapeutic benefit even without the use of a drug, if the patient cannot tolerate an optimal drug, cannot tolerate any drug, or can receive helpful therapy from a drug-unaided device.

It is hoped that the invention herein can contribute to the campaign against AD and, in some small way, respond to the passing of one of our own parents due to AD. The scope of the invention is targeted at the full range of such deposition-related diseases.

B. Alzheimer's and Related Diseases-Histology

Alzheimer's disease is marked by the progressive loss of memory, on-set of confusion, dementia, and death. The contributing genetic, environmental, and metabolic factors are unclear and appear to vary among patients. Genetic origins have been identified with mutations on the beta-amyloid precursor protein in some patients.

Patent application WO95/19178 to Iqbal gives an excellent overview of Alzheimer's histology as follows. The disease impacts the neocortex, especially the hippocampus, and is characterized mainly by two types of lesions.

NFTs or neurofibrillary tangles of PHF (paired helical filaments) in the neurons or neuronal perikaya. PHF is also found in dystrophic neurites surrounding the extracellular deposits of beta-amyloid in the neuritic plaques, and in the dystrophic neurites of the neuropil as neuropil threads.

Neuritic senile plaques of beta-amyloid in the extracellular space.

Beta-amyloid is a peptide composed of about 40 amino acids. Neurons affected by amyloid deposition go from normal, to partially functional, to dead, leaving behind plaque tangles. Beta-amyloid can also (sometimes) accumulate in the lumens and lumen-walls of brain vessels. Generally seen though are non-lumen situated diffuse deposits of beta-peptide polymer, which form insoluble amyloid and are an AD signature.

Similar histologies to (1) and/or (2) above are also found, for example, in Guam-Parkinsonism dementia complex, Dementia Pugilistica, Parkinson's Disease, adult Down Syndrome, subacute Sclerosing Panencephalitis, Pick's Disease, Corticobasal Degeneration, Progressive Supranuclear Palsy, Amyotrophic Lateral Sclerosis/Parkinsonism Dementia Complex, Hallervorden-Spatz Disease, Neurovisceral Lipid Storage Disease, Mediterranean Fever, Muckle-Wells Syndrome, Idiopathetic Myeloma, Amyloid Polyneuropathy, Amyloid Cardiomyopathy, Systemic Senile Amyloidosis, Hereditary Cerebral Hemorrhage with Amyloidosis, Alzheimer's disease, Scrapie, Creutzfeldt-Jacob Disease, Fatal Familial Insomnia, Kuru, Gerstamnn-Straussler-Scheinker Syndrome, Medullary Carcinoma of the thyroid, Isolated Atrial Amyloid, Beta2-Microglobulin Amyloid in dialysis patients, Inclusion Body Myositis, Beta2-Amyloid deposits in muscle wasting disease, and Islets of Langerhans Diabetes Type2 Insulinoma. The Polyglutamine diseases including Huntington's Disease, Kennedy's Disease, and at least six forms of Spinocerebellar Ataxia involving extended polyglutamine tracts are further examples of such deposits.

For a focus of the teaching, we herein concentrate on Alzheimer's Disease and its fairly well-characterized intracellular amyloid beta plaques and its accompanying cellular tau-fibril plaques. The reader should keep in mind that the teaching is applicable to other types of deposits as well, including Prion-Proteins, Lewy Bodies, Nuclear and Cytoplasmic Inclusions, Cytoplasmic Tangles, and Bunina Bodies, to name a few.

So with AD, we have a disease characterized by two depositing insoluble proteins, above-normal quantities of beta-amyloid plaques, and new tau fibrillary tangles. The plaques generally take up residence in extracellular space, whereas the fibrils can be found inside of brain cells. As time goes on, such deposits can easily displace (kill and replace) half of the healthy brain cell volume.

C. Prior Art Targeting of Alzheimer's for Therapy and/or Diagnosis.

In general, most of the work in AD therapy drugs falls in one of a few categories: (1) ways to interfere with the formation of beta-amyloid or tau deposits, (2) ways to reverse (dissolve, for example) beta-amyloid or tau deposits, (3) ways to enhance nerve growth to repair, replace or supplement damaged nerve cells, (4) ways to correct neurotransmitter and communication disfunction between brain cells, the dysfunction directly or indirectly having been caused by the AD process, (5) ways of reducing inflammation, an AD hallmark, (6) ways of reducing oxidative stress, a suspect contributing factor and (7) ways of suppressing brain cell aptosis due to AD-imposed stresses.

Given the above, researchers' interest in anti-inflammatories, antioxidants, and hormone-replacement therapy (estrogen treatments, for example) are not surprising. There is considerable historical unrelated circumstantial evidence that these avenues may bear some fruit. However recent hormone replacement studies have shown some undesirable side-effects.

The body of work that has attempted to address the specific and unique issue of Alzheimer's disease (and of certain related amyloid-plaque-forming diseases) is reviewed now. By “address” we mean one of (1) diagnosing Alzheimer's or (2) treating Alzheimer's with drugs, medicaments, vitamins, minerals or herbs and/or with a device. There are currently no AD-therapy devices other than the experimental CSF drainage shunt of Eunoe Inc. discussed in the accompanying Information Disclosure Statement. The non-AD work of Hynynen et al is described below, based on the following references: U.S. Pat. No. 6,074,352; WO 98/07373; U.S. Pat. No. 5,752,515; U.S. 2002/0038086 A1; “Micro-Receiver Guided Transcranial Beam Steering”, Clement, G. and Hynynen, K., IEEE Transactions On Ultrasonics, Ferroelecrtrics and Frequency Control, 2002, vol. 49, no 4, pp 447-453, IEEE Institute Of Electrical And Electronics.; and WO 02/09608 A2. In this body of work, Hynynen teaches cavitation and focused-ultrasound heating of brain tissues under MRI guidance for treating tumors. The scientific community has now moved away from direct (not aided by microbubble agents, for example) cavitation because it is uncontrollable. The “focus-scanned ultrasound under MRI” system taught by Hynynen is extremely slow, extremely expensive, nonportable, and ill-suited to treat AD that does not present a discrete target. It may be useful to treat localized brain tumors where the treated volume is relatively localized and his acoustic scanning means do not have to be used to scan over large volumes. Nothing is taught by Hynynen regarding the distributed plaques (or even the existence of plaques) of many neurodegenerative diseases nor what acoustic and/or drug mechanisms should be used or combined to slow, stop or reverse such plaques as we teach herein. We teach a simple and low-cost system not requiring imaging or point-focusing (scanned or not) that interferes with specific plaque processes in specific manners preferably using the combined forces of drugs and ultrasound. Hynynen also teaches nothing about combined drug/ultrasound action, i.e., wherein a drug's chemical or biological action at the site of treatment is accelerated by ultrasound, resulting in a shorter, more complete or safer process. Hynynen teaches cavitation-induced opening of the blood-brain barrier (BBB) wherein a microbubble contrast agent opens the vascular lumen walls to the brain cells, but then teaches that the drug merely passes through the opened lumen walls and performs its function (not defined) somewhere else (not defined) without the further aid of ultrasound. The present inventors note that most AD drugs under development are engineered to pass through the BBB so as to avoid that brute-force BBB acoustic-opening approach. As will be known to ultrasound practitioners, the acoustic properties of plaques are also different than that of normal brain tissues. Since Hynynen does not discuss plaques, he does not discuss plaque-ultrasound interactions or acoustic or drug mechanisms for destroying or interfering with plaque formation and deposition. No prior art teaches amplification or extension of an AD drugs action via ultrasound exposure, nor for any drug used to treat any deposition-related brain disease. Finally, Hynynen uses contrast agent cavitation to open the BBB. This requires administering a contrast agent, which either has a drug in it or needs to be followed by a drug. The present inventors preferably utilize BBB-permeable drugs.

The prior art (all are experimental) AD-diagnosing tools are usually based on an analysis of bodily tissue or fluid samples looking for the chemical, genetic or protein fingerprints of insoluble amyloids or of associated processes. A variety of (experimental) imaging means have also been proposed to aid in diagnosis of Alzheimer's. Many of the drugs developed for treatment are also useful as screening tools useful to identify further new drugs. No viable therapy devices have yet been disclosed which are specifically designed or suitable for treating AD or any other kind of neural distributed plaques or plaque-forming processes other than the aforementioned Eunoe CSF drainage shunt.

It will be noted that with the exception of the Eunoe CSF shunt, all prior art for AD therapy and/or diagnosis has involved drugs, medicaments, or body-fluid lab-tests. There are no other known devices for the provision of therapy.

D. Prior Art Amyloid Imaging.

There has been some work to try and directly image ongoing or incipient amyloid deposition or loss of cognitive function related thereto. It will be seen that much of this work pertains to structural and functional (or metabolic) imaging using MRI, fMRI, and PET-based tools. These can give information at several stages of the disease process.

It will be noted that the imaging means and the drug-agent means act independently in any therapy applications mentioned above (including the dual imaging/therapy drugs or agents). In other words, there are no synergistic or symbiotic therapeutic effects described for AD therapy using a drug and an external tool, imaging or otherwise. The drug therapeutically acts on its own if it is used and if it provides therapy at all.

There are a number of recent ongoing funded research projects in the general areas of drugs, diet and imaging which are approved and funded by the Alzheimer's Association itself (see the accompanying Information Disclosure Statement). These can be regarded as designed using the latest understanding of all medical and social aspects of the disease. It will be noted that there is a total lack of device therapies yet taken seriously. The Eunoe device does not appear on the organization's funded project list despite the FDA approved clinical study ongoing.

E. Prior Art Acoustic Lysis or Lithotripsy of Concretions, Clots and Plaques.

It will be appreciated that the prior art now discussed is unuseable for the present inventors' current purposes. The reasons are:

(a) Most of these devices are very close-range concretion (or clot) smashing devices using very high (cavitating) energy densities. Such targets must be isolated and reachable via natural lumens.

(b) Most of the rest of these devices are long-range devices for use in and through soft tissues in situations wherein treating large volumes of tissue is not necessary (e.g., gallstones) and there is no intermediate bony structure in the way of the treatment beam. These also require imaging if they are to be aimed.

(c) The concretions, clots or plaques being attacked are of fundamentally different chemical makeup than AD plaques and tangles, so even in the few cases where a drug is used with the device, the drug would not be useful for AD plaques. The present inventors' target application, in the brain, has distributed plaques surrounded by fragile living brain cells. The treatment volume inventors require can easily be half the volume of the cranium. Furthermore, the human skull presents a huge acoustic impediment, which is locationally variable in properties, unlike the intervening soft tissues of the following art.

So there is a body of prior work utilizing ultrasound to break up concretions and stones in body organs or blood clots in vasculature. In general, since the fragile brain has not been involved to date, considerable acoustic energy has been used to pulverize such objects in a mechanical (minimally heating) pulverizing mode of operation. Very intense ultrasound or sonics is either delivered directly into the lumen on a catheter or is delivered by a very large emitter located external to the body. In most cases, the destruction driver has been entirely acoustic without the aid of drugs. More recently, in limited applications, a combination of a drug and ultrasound have been shown to dissolve close-in blood clots in lumens specifically employing blood antoclotting drugs. In any event, the devices and the collateral damaging cavitation phenomenon cannot be allowed in the brain and even if it could, there is no teaching compatible with working through the skull on distributed plaque immersed in fragile living neurons.

All of the prior art devices address vascular thrombi, typically blood clots found in lumens OR stone concretions found in organs such as the liver or kidney. For the blood clots in lumens, clot-dissolving drugs are also co-employed in some cases. All of the described therapeutic devices involve high acoustic power with the ability to smash such objects mechanically at a focus. In some cases, they involve the use of encouraged (seeded) cavitation bubbles, which amplify the erosive effect on blood clots in lumens. This is a purely physical acceleration. Cavitation is not taught as a recommended method of attacking organ stones, as one can damage adjacent healthy tissues with the large focus of external acoustic exciters. For the intraluminal devices taught, the ultrasound is intense and near-focused in a very small region and is arranged to avoid hitting healthy lumen tissue. The last reference makes it clear that with contrast agent gas bubbles (or cavitation bubbles) that even diagnostic-imaging power-levels of ultrasound can cause sonoporation or even lysis of healthy cells.

None of these device references teaches the therapy of Alzheimer's disease (or any other deposition related neural disease) using acoustic devices or drugs or using combinations of acoustic devices and drugs. This is true not only of the acoustic delivery but also true of the inherent targeted usefulness of the drugs themselves. A good bloodclot dissolver is not a good amyloid plaque/fibril dissolver. Getting acoustics into the brain, as we will describe, is also a unique problem in and of itself and has only recently gained attention. Furthermore, none of this art teaches any brain drugs that have their chemical or biological action itself accelerated by ultrasound.

F. Prior Art Devices for Performing Acoustic Tissue-Therapy in the Body.

The focused subsurface thermal-heating effects of ultrasound have been proposed to kill cancer tumors or to stop bleeding from open wounds, for example. Tissues respond, in part, to high-power higher-frequency (generally greater than 2 MHz) ultrasound by heating. Such heating, depending on the temperature, is known to promote coagulation of blood and even necrosis of living tissues. These effects are thermal effects as opposed to the predominantly mechanical lithotripsy effects seen at low frequencies in the above clot-smashing or stone-smashing references. Imaging means have often been combined with such thermal therapy because it is critical to know which tissues are being heated.

All of the hyperthermia (heating) devices are arranged to deliver many-cycle heating acoustics through soft tissues or bodily fluids. Temperature rise (and time at temperature) is the predominant control variable. All of the devices, in order to optimize heating effects, would be required to operate at greater than about 2 MHz, and preferably in the 2.5 to 5.0 MHz range for efficiently heating tissues at any depth rapidly. None of the above inventions is applicable to selectively destroying distributed plaques without also destroying adjacent healthy tissues as taught. Plaques and fibrils associated with Alzheimer's cannot be purely thermally destroyed and furthermore cannot be selectively thermally targeted even if they could be. Pure thermal treatment would result in an even more insoluble burned or charred material with associated undesired gas vapor bubbles causing possible embolisms.

G. Prior Art Devices for Performing Acoustic Therapy in the Brain.

To begin with, A. Malcolm in “Ablation of Tissues using High-Intensity Focused Ultrasound” describes the history of focused ultrasound surgery R&D for the brain going back to 1942. Around 1977, people began suggesting directing ultrasound through the skull rather than through a hole in the skull called a craniotomy as they were pre-1977. This work was directed to heating and ablative thermal lesion forming, particularly as applied to killing isolated tumors.

More recently, several investigators, including Hynynen, have thought about the difficult problem of doing highly focused (to a point) ultrasound therapy within the skull from outside the intact skull in terms of providing a proven fine-focus steerable to a selected point. The difficulty is that the skull is highly lossy (attenuative) to acoustics and is also reflective to acoustics because the acoustic impedance of bone is quite different than that of tissue or blood (or a water coupling bag). Furthermore, the thickness of the skull varies considerably from point to point and from patient to patient so further phase-delay errors are incurred if one were to try and use phase-control for focusing or steering a multitransducer or multielement acoustic beam through the skull. No disclosed device has been described which is specifically targeted at the unique problem of diffusely-distributed and widely-distributed Alzheimer's plaques in an otherwise functional brain, as we shall now see. Alzheimer's (and its previously disclosed similar plaque-forming diseases) are unique among neurodegenerative diseases due to their deposition of toxic and displacing deposits of distributed macroscopic and microscopic plaque of two different varieties across wide regions. Prior art localized ablation, necrosis and cavitation-based ultrasound are not the answer to this problem from a safety and from a cost/time point of view. In fact, in many cases, such therapies would probably render the plaques burned and permanently insoluble even in the presence of drugs. Substantial adjacent healthy neurons would also be killed.

The brain-therapy art described in the Information Disclosure Statement is focused on one of a few approaches to treating brain problems, none of which are described as involving operating upon plaques. These approaches are (a) cavitation smashing of undesired brain targets, (b) thermal necrosis or burning of undesired brain targets, (c) acoustic opening of the blood-brain barrier to deliver drugs to the brain therethrough, and (d) accelerated dissolution of blood-clots using specific bloodclot dissolvers.

Direct cavitation has been demonstrated to kill healthy cells of all types, including in front of the acoustic focus as treatment progresses; thus, it is not being pursued as a prime approach beyond the historical kidney-stone lithotripters wherein the macroscopic and isolated target is isolated in a surrounding fluid and adjacent tissue damage can be avoided or at least tolerated. In fact, during lithotripsy, it is virtually impossible to avoid some cavitation. It has also been found extremely difficult to control direct unaided cavitation as there are several variables that determine when cavitation occurs.

Thermal necrosis via focused ultrasound is possibly good for isolated brain tumors, particularly ones that are beyond surgery. It does some nearby damage and it cannot be applied to distributed targets easily without killing excessive amounts of adjacent good brain cells. Device-wise, it will probably compete for tumor-treatment with directed radiation and invasive cryotherapy, rf or microwave ablation.

Acoustically-assisted drug delivery through the blood-brain barrier (BBB) may be a useful means of getting drugs into the brain that normally will not penetrate that barrier. Fortunately, since the prior art was published, there has been a lot of progress recently on modified (or new) drugs which themselves can penetrate this barrier in an unaided manner. The risks of “temporarily” opening this barrier acoustically are unknown in terms of any long-term affects or undesired short-term effects in human subjects. The jury is still out on this approach. The preference is to use a drug that has at least some useful relevant barrier-permeating potential itself Also, it is recently thought that even minor heating or cavitation can cause ischemia or other brain damage. All of these risks and unknowns are preferably avoided by the present inventors.

There remains a need for a therapy for the treatment of Alzheimer's and other deposition-related disorders of the brain that can be utilized in a clinic, a doctor's office, a hospital bedside, an out-patient facility or even a nursing home or patient's home. It should not require careful focal aiming or volumetric scanning of sequences of small target positions nor ablative or cavitating damage and it should not require long periods, if any, using million-dollar capital equipment which will never be sufficiently widely available nor inexpensive. Preferably, it will have a device component and a drug component that are symbiotic in that the therapy energy exposure furthers the action or ultimate benefit of the drug or medicament.

### DISCLOSURE OF INVENTION

In accordance with the present invention, a system is provided for the therapeutic treatment of abnormal protein-related or prion-related diseases of a human patient's brain or neurological system. The system comprises:

(a) acoustic exposure therapy comprising at least one acoustic or vibration emitter for acoustically or mechanically coupling, directly or indirectly, acoustic or vibratory emissions into a brain or neurological region which has been, is, or is expected to potentially be subject to the nucleation, growth or deposition of abnormal-protein or prion-related deposits, nodules or bodies;

(b) means for exciting the emitter to emit acoustic or vibration energy with a desired characteristic; and

(c) the emitter adapted to deliver therapeutic acoustic or vibration energy, directly or indirectly, to at least one of the brain or neurological region, the therapy designed to provide, enable or accelerate at least one of the following therapy processes:

(i) physical breakup, breakdown, erosion, dispersion, disentanglement, de-aggregation, redistribution, dissolution, de-agglomeration, de-amalgamation or permeation of at least some the deposits, nodules or bodies,

(ii) interference in, slowing of, or reversal of at least one physical, chemical, biological or genetic deposit, nodule or body formation-process, formation-sequence or formation pathway anywhere in the process, sequence or pathway, and

(iii) aiding the recovery, growth, regrowth or improved chemical, physical, biological, genetic or cognitive functionality of brain-related or neurological-related cells, physiology or functional pathways negatively impacted or stressed by the deposition of, formation of, or presence of the deposits, nodules or bodies or their associated formation processes.

Further, a method is provided for the therapeutic treatment of abnormal protein-related or prion-related diseases of a human patient's brain or neurological system. The method comprises:

(a) exposing the patient's brain or neurological system to acoustic or vibratory therapy from the system described above;

(b) exciting an emitter to emit acoustic or vibration energy with a desired characteristic; and

(c) delivering the therapeutic acoustic or vibration energy from the emitter, directly or indirectly, to or through at least one of the brain or neurological regions directly or indirectly affected by the disease or supporting the progression of the disease.

Additionally in accordance with the present invention, a system is provided for the therapeutic treatment of abnormal protein-related or prion-related diseases of a human patient's brain or neurological system. The system comprises:

(a) means to direct acoustic or vibrational energy into or through at least one such diseased or potentially diseased anatomy portion; and

(b) an optional drug, medicament or controlled dietary content capable of contributing to the therapy also directly or indirectly delivered to the portion,

wherein the acoustics and optional drug together at least slow a cognitive loss process by slowing, stopping or reversing a deposition process.

Further in accordance with the present invention, a method of at least temporarily slowing, stopping or avoiding a patient's cognitive losses associated with a neural deposition disease is provided, comprising administration of acoustic or vibrational energy into affected or potentially affected patient anatomy portions, the emissions altering, blocking or reversing a cognitively-damaging deposition process, at least temporarily.

Still further in accordance with the present invention, a system for at least temporarily slowing, stopping or avoiding a patient's cognitive losses associated with a neural deposition disease is provided, comprising the administration of acoustic or vibrational energy controllably emitted from an acoustic emitter into affected or potentially affected patient anatomy portions, the acoustically coupled emissions altering, blocking or reversing a cognitively-damaging deposition process, at least temporarily.

The system and methods of the present invention treat Alzheimer's and other deposition-related disorders of the brain and neurological system, with minimal adverse side effects to the patient using the preferred low power-levels, synergistic drugs, optional cooling means (for somewhat higher power levels), and, if necessary, anti-inflammatories to minimize any potential inflammatory side-effects of the ultrasound exposure itself.

### BRIEF DESCRIPTION OF THE DRAWINGS

The drawings referred to in this description should be understood as not being drawn to scale except if specifically noted.

FIG. 1 is a therapy sequence menu showing various therapy options, employed in the practice of the present invention;

FIG. 2 is a view of the head of a patient, with head-mounted therapy transducers in accordance with an embodiment of the present invention; and

FIG. 3 is a schematic diagram of the therapy system and cabling.

### BEST MODES FOR CARRYING OUT THE INVENTION

Reference is now made in detail to a specific embodiment of the present invention, which illustrates the best mode presently contemplated by the inventors for practicing the invention. Alternative embodiments are also briefly described as applicable.

The Present Invention.

The device or device-supported treatment of Alzheimer's plaques (or related plaque processes) in the living human brain is a challenging balancing act. One cannot expect to simply apply prior solutions to a seemingly related problem. It is a different problem. We have shown that prior art clot and plaque removal devices have been primarily catheter-based high-intensity nearfield acoustic smashers or mechanical cutters. In Alzheimer's, the plaques are located amongst the brain matter itself in a distributed way and only sometimes is situated (in addition) in the brain lumens. Thus, a lumen-based therapy device for the brain would have to mostly treat neural tissues adjacent but outside (mostly well-outside) the lumens. Although this is physically possible with a very small device and we include it in the scope of our invention, we believe that it would involve a very slow process with a lot of auxiliary imaging to guide it. Such a small device would be power (operating temperature) limited because heat sinking, regardless of whether it be forced or natural, is very limited. Such a device would have limited range from the lumen because of beam integrity issues and would likely have to be mechanically or electronically scanned.

We have described lithotripters that, for brittle isolated targets such as kidney-stones, can smash such objects and then the resulting insoluble debris can then be naturally but painfully passed out of the body. The operating parameters of these devices, as verified by their integrated ultrasound-imaging means, cause very substantial macroscopic shock waves and explosive cavitation events. These stones appear to literally explode in a froth in the controlling ultrasound images. It should be obvious that these levels of violence and bubble generation cannot be gotten away with in the brain wherein the plaque is often distributed and surrounded (or interdispersed) intimately with healthy or struggling fragile brain matter. Such bubbles as seen for kidney stones would also serve to mask the ultrasound energy in a distributed treatment of Alzheimer's if not outrightly cause an embolism stroke.

The opening of the blood-brain barrier (BBB) by brute acoustic force (via cavitation and/or heating) seems heavy-handed and there appears to be a significant concern among researchers that other damage will be caused both near the skull and inside the brain. Thus, it is not surprising to see Hynynen's new work in ultrasound-contrast, agent-nucleated cavitation for this purpose, wherein the acoustic energies are dramatically lower. This is in keeping with Unger's contrast-agent work as well such as that described in U.S. Pat. No. 6,088,613 “Method Of Magnetic Resonance Focused Surgical And Therapeutic Ultrasound”.

In any event, one must remember that what Hynynen is doing is opening the walls of the brain lumens so that an unspecified self-acting drug may now pass across these walls (the BBB). The cavitation events are in the lumens and not in the brain matter itself as-taught. Thus the cavitation events do not operate upon brain-matter distributed plaques. We have also described a reference that shows that even diagnostic-imaging level ultrasound exposures in the presence of contrast-bubbles can cause sonoporation and some cell damage, despite the low acoustic power levels.

We have discussed blood-clot dissolving references for lumens outside and inside the brain. What was taught is that with the use of highly specific blood-clot dissolvers or enzymes that ultrasound can enhance the rate of dissolution of such blood clots using such drugs.

Finally, we have discussed several references that utilize real-time imaging in combination with a brain therapy. Again, although this is technically possible for just about any brain therapy (and certainly advised for many invasive targeted surgeries), we believe that it is impractical to perform MRI-guided therapy (imaging during therapy) on millions of Alzheimer's sufferers if the therapy/imaging tool is extremely expensive, of low-throughput, and not necessarily locally available. Repeated therapies make it even more impractical.

What would be ideal is a therapy tool that can be utilized in a clinic, a doctor's office, a hospital bedside, an out-patient facility or even a nursing home or patient's home. We will define this as “portable” as opposed to a truly fixed capital asset such as an MRI or fMRI system with a cointegrated or adjacent ultrasound therapy device. By portable we also mean it can be moved at low or modest cost with minimal manpower or preferably without the use of a rigging or drayage firm, heavy truck or forklift.

The present inventors believe that real-time imaging throughout each and every therapy session, using the invention taught herein, is not required, but that imaging used as a preparatory, staging or follow-up tool is at least desirable. Despite this, it is possible to integrate certain non-imaging features in our treatment system that assures that an out-of-control therapy is not delivered. In other words, the invention should preferably not tie up expensive imaging equipment (such as MRI) every time and all the time the patient is receiving the therapy. Imaging is preferably used for interspersed therapy planning and progress monitoring sessions instead, if it is used.

The first major feature of our system is that it can preferably deliver several therapy modes over large brain/neurological volumes or regions without requiring tight acoustic focusing to a small point and subsequent beam scanning. Prior art therapeutic ablators or stone-shatterers focus to a point in order to get high power density at the focus and thereby enable heating, smashing or cavitation as do all current ultrasonic imaging devices in order to get good signal to noise ratio from the image-spot being scanned. Focused therapy devices must be scanned, either mechanically or electronically, to sweep the hotspot throughout a significant volume. A hotspot that is ablated is not selectively-ablated in that ANYTHING located at the focus (or perhaps nearby even in front of the focus) will also be burned or damaged. By “focusing”, we mean mechanical focusing to a fixed or moving point or line to gain large mechanical amplification or electronic focusing to a fixed or moving point, line or fine volume to again get high gain or amplification of acoustic intensity. When we utilize multiple transducers, it is most often for reasons of spatial coverage achievable without scanning (or without transducer rearrangement) and not for prior art purposes of significant geometric amplification. Thus, we generally utilize unfocused, weakly focused or simply collimated beams to minimize or avoid scanning altogether. These transducers have broad coverage. Our therapy modes can preferably all be delivered without beam-steering in an effort to offer a simple inexpensive solution. Ideally, our transducers can deliver constant power density vs. tissue depth taking into account attenuation. Thus large brain volumes can receive a relatively uniform power density using only slight focusing. The aim is to treat uniformly with minimal or no scanning whatsoever. Our acoustic or vibratory therapy is able to beneficially operate upon plaque and plaque-forming mechanisms while leaving substantially-alone healthy tissue and unrelated healthy processes and this feature is enhanced by the selectivity of the drug's action. That is to say that the therapy is not primarily dose-limited as it is for radiation treatments, for example. In principle, healthy tissues can undergo numerous therapies of the invention without long-term harm. This paradigm allows for blanket exposure if not over-exposure without long-term harm being done. Blanket exposure is far cheaper than any exposure requiring extensive aiming of a beam.

The second major feature of our system is that at least one drug or medicament and the ultrasound preferably work, at least some of the time, in a synergistic manner, preferably, the action of the drug on the brain matter (plaques, desirable cells/fluids, neurons, brain-cells etc, neural processes) of interest, is enabled, accelerated or extended by the ultrasound exposure or a side effect of the ultrasound exposure (such as slight local heating or low-level sonoporation). Note that this is fundamentally different and more complex than using ultrasound to get a drug through (transported across) the BBB so that it can perform its own purely chemical or biochemical function after the ultrasound is turned off. This is synergistic or cooperative operation of ultrasound and a drug. The “drug” or medicaments may also include nerve growth factors or even stem-cells targeted to grow into brain cells in some of the steps of the taught process. The symbiotic drug/ultrasound effect(s) may occur either because the drug and the ultrasound are simultaneously present in a tissue region or because the tissue being treated by the ultrasound (or drug) has had prior exposure to the drug (or ultrasound). By synergistic or symbiotic we mean that together the ultrasound and the drug(s) cause more benefit than if only one of them were delivered to the patient. Thus, the effects could be merely additive but could also be multiplicative or coamplifying. To be very clear what we mean by synergistic in the broadest sense is that (a) at a minimum, one gains additive effects of the drug and the ultrasound and, more preferably, (b) because both ultrasound and a drug are used each at some point at least one of them enables or enhances the rate or extent of the action of the other. Again, this can take place through all manner of simultaneous or sequential exposures to the ultrasound and the drug together or separately, as both ultrasound and drug likely have some latent effects that do not go away immediately.

The third major feature of our system is that its acoustic emissions may be applied to achieve one or more of three different therapy processes, all of which can benefit Alzheimer patients (or other deposition-disease patients) and each of which operates by different mechanisms. The three processes can be sequential, Simultaneous or interleaved or may be used selectively. Any of the three can be operated in the weakly focused or collimated mode not requiring beam-steering or strong focusing. Such focusing measures can locally accelerate these three processes at the expense of new scanning time, but we prefer as simple a system as possible. In our preferred weakly focused or collimated modes, we also maintain energy densities at levels low enough that minimal if any cumulative undesired damage is done to non-target tissues. Thus, excess treatment may be deliverable to assure a good result without undesirable side-effects.

The first process is senile and fibril-plaque breakdown (per the AD example), which we define as including all manner of erosion, breakage, dissolution, disaggregation, deagglomeration or deamalgamation of plaque. As a reminder, although we focus here on Alzheimer's beta and tau plaques and fibrils, these therapy processes are also applicable to prion-based plaque and Lewy body diseases as described. So, continuing, in other words, existing deposits amongst brain matter are having their integrity attacked surface-wise and/or bulk-wise. We will now define any of these as “breakdown” and will specify that breakdown can be measured with an extent using two possible parameters, The first breakdown parameter is simply a % volume reduction in plaque as measured by any preferred plaque-load indicator such as MRI or a spinal fluid sample or blood sample. The second breakdown parameter we define herein relates to the affinity of any existing plaque surfaces or materials to agglomerate more plaque. So in other words, there are two ways of dealing with an existing plaque load: (1) make it go away to 0% or to some finite percent of what it was, or (2) make sure no more plaque can agglomerate to its surface so that it does not grow further. Obviously, if one can make the agglomeration go to zero, that (preexisting) plaque will stop growing, but all plaque must be thus converted or else the deposition mechanisms may simply put it elsewhere. By deactivating the surfaces (internal and/or external) of existing plaque (as opposed to removing said plaque), one should make it more difficult for new agglomeration on the deactivated plaque. That is, at least one forces it to deposit elsewhere at a higher activation energy threshold (such as required for a new nucleation). Deactivation could be as simple as chemically tying up plaque surfaces. The reason we include both of these mechanisms is that both are possible and that removing large volumes of (especially densely deposited) plaque may itself be a physiological problem in the sense that the remaining healthy brain matter will become mechanically unsupported (tissue-wise) if such removal is rapid. We also include in the scope of our invention the use of a backfilling material that literally replaces some or all of the plaque for at least a short time in order to avoid sudden collapse or distortion of remaining brain tissues. Such a material may also be biodegradable or absorbable. Such a material may even be formed in place as an engineered by-product of the plaque breakdown processes.

The second process is interference in one or more of the chemical, biochemical (including genetic) or physical pathways that form the plaques. In other words, attack at least one attribute of the plaque-making process itself somewhere. Note here that we are treating a process that is creating (or will soon create) unacceptable amounts of deposited material. This would include deactivating or eliminating any or some amount of required precursor species or materials.

The third process is improving the perfusion of local and/or nearby (to plaque formation regions) degraded brain-tissues and accelerating neural and neuro-functional recovery processes. This most benefits adjacent (to plaque) neighboring brain cells but also remaining healthy cells situated further away from the plaques. By definition, in this third category, we include acoustic exposures, which improve cognitive function and signaling-pathway function. Acoustically-forced perfusion or cell-membrane diffusion, as long as it can be kept from being destructive or inflammatory (with drugs or low power, etc.), should improve local cell growth, viability, and molecular transport processes leading to improved cognitive function. In this third process, since it includes neuron recovery, we also include emerging stem-cell or bone-marrow stromal-cell (BMSC) therapy wherein new neural cells are grown in-vivo or in-vitro and utilized to replace compromised, missing or insufficient healthy ones. So we specifically note that a “drug” within the scope of the present invention and any of its three processes can include newly introduced cells, such as stem cells, that are intended to become brain cells or neurological cells or structures. Such a drug, in addition to the many taught in the references, may also include antioxidants, hormone replacements, antibodies to plaque or plaque related species. These are also generally thought to be likely beneficial Alzheimer drugs. In an extremely simple application this perfusive driving force could help better distribute a drug.

It should also be understood that removing plaque or stopping plaque infiltration will also frequently result in improved cognitive function as amyloid beta/tau physical and toxic stresses are reduced and acoustic therapy has unavoidably bathed at least some of the remaining cells during the removal (or interference) process(es). Therefore, improved cognitive function is expected to be a frequent beneficial byproduct of processes 1 and 2 (breakdown and interference) as well as of process 3. This improvement will usually be most evident some time after therapy, i.e., several weeks to many months later.

Essentially, the preferred embodiment of the present invention provides high-coverage acoustic emission from one or preferably multiple skull-coupled emitters that together bathe large brain volumes with relatively low-intensity ultrasound (compared to ablation, direct unaided cavitation or lithotripsy intensities). Generally, acoustic power intensities on the order of 0.005 to 15 watts/cm² are preferred. Preferably no beam-forming (to obtain significant gain or to “steer” a beam) is involved and preferably the (therapy) transducers also do not have to do significant beam-forming for the sake of ultrasonic imaging to monitor the procedure. Use of a separate array or transducer to image is optional. Methods are also described wherein the skull is utilized as an active acoustic component (or even resonator) such that any gaps between emitters are “filled-in” with emissions also. We prefer not to do acoustic beamforming and steering of a moving focal point because it is expensive. We prefer to use stationary transducers that are close enough and weakly focused or diffuse enough that we effectively have minimal or no treatment gaps between them. If need be, slight phase delays can be applied between adjacent transducers or multiple “beams” from individual transducers can be overlapped. But the point being made here is-that we are preferably not forming a “focus” nor moving a beam-formed “focus” in the conventional sense of thermal-ablation ultrasound of ultrasound imaging wherein large focal gain is a primary goal. We, however, include in the scope of the present invention the use of beam-formed treatment, as there may be other advantages, albeit expensive, of that system complexity such as simultaneous ultrasound imaging. A simple nonbeam-former without 3-D (3-dimensional) steering is more suited to the task of treating millions inexpensively and is our preferred embodiment.

The drug(s) supporting or enabling at least one of the three processes just described is preferably capable of at least passing through or across the blood brain barrier in useful concentrations in an unaided (no ultrasound aid required) manner. Thus, a therapy comprising at least one of processes 1, 2, 3 is possible without acoustically opening the BBB. The drug may be administered at least one of before, during or after the therapies, but preferably before and during. In this manner, the drug has some time to diffuse if not attach to targeted plaques, for example by using known receptor or staining approaches from the references.

We wish to note that the third perfusion or transport mechanism described above may also provide for enhanced mobility of species from within the brain or neural system outwards into the bloodstream or other portions of the body. Further, acoustic illumination serving any or all of the mechanisms #1-3 above may allow for easier egress of “dirty” CSF from the brain into the bloodstream under the scalp or from the brain into the CSF-filled ventricles. CSF naturally passes into the bloodstream from the brain and we know that ultrasound will enhance this mobility and therefore allow for greater rates of removal of undesirable species from the brain or from brain CSF into the bloodstream. The invention may also allow enhancement of toxic concentrations. Thus, the invention could be used in combination with a Eunoe-type shunt wherein the performance of both is mutually enhanced.

Recall that at least one of the used drug(s) and the ultrasound (sequential or simultaneous with drug(s)) are preferably symbiotic in the sense that the combination of the drug and the ultrasound provides more useful, more extensive, or more accelerated therapy than the drug alone or the ultrasound alone. Even in a sequential ultrasound, then drug approach, the tissue experiences a decaying effect of the ultrasound (tissue-exposure effects linger), even if the ultrasound has been turned off. So the drugs effect is still accelerated even though the ultrasound may be turned off. We include in the scope of the present invention driving a drug across the BBB (wherein no useful concentration in the brain will result otherwise), but it is not the preferred approach due to potential side-effects we have already described. So by symbiotic or cooperative ultrasound and drug, we mean that regardless of whether the drug and ultrasound are delivered or resident in the brain simultaneously or sequentially, the effect of the ultrasound exposure causes the drug to have a greater, faster or more extensive or long-lasting effect than it would without the ultrasound exposure. At an absolute minimum the drug and the ultrasound have additive effect as previously stated.

Another feature of our system is the optional use of a drug (or device) to lessen the effects of the acoustic therapy itself. For example, if the acoustic emissions cause a ringing in the ears of the patient, then one can sedate or put the patient under (drug) or one can possibly provide noise-canceling earphones (device). If the desired acoustic exposure parameters cause some level of background inflammation, then an anti-inflammatory can be administered solely for this purpose if desired. We have already mentioned that anti-inflammatories are beneficial treatments for AD itself. If a particular acoustic frequency or duty cycle causes undesirable psychoacoustic reactions then one may design away from those particular conditions.

The preferably symbiotic drug/ultrasound relationship is most preferred for the first process, that of attacking or otherwise contributing to the “breaking down” of plaques themselves. Because massed diffuse plaques have high attenuation in-situ and represent acoustic impedance and scattering discontinuities somewhat like bone does, it is possible to selectively and substantially absorb acoustic energy, particularly in diffuse plaques, in the form of ultrasound-induced micromechanical distortions and heating. This is actually very similar to the design of an acoustic transducer for imaging wherein one wants any transducer backer construction material to be highly attenuative and scattering, so fine fiber particles (similar in size to Alzheimer tau fibrils) are mixed in the polymer backer material, as is widely published in the transducer art. The drug acts more quickly because it is driven into the plaque regions, driven into the plaque itself, and because due to the ultrasound exposure, it has higher solubility in the plaques and because the micromechanical damage removes any potential blocking by-products of any reaction thereby accelerating the renewed removal reaction. So distributed plaque acts to capture and dissipate acoustic energy, and this only enhances the effect of any drug.

The preferably symbiotic drug/ultrasound relationship may also or instead be used for the second interference process such as to allow the driving of the drug into all regions and acceleration or extension of the reaction extent. In particular, in this second interference process, the ultrasound may be used to enhance cross-membrane (cell membrane) movement of a blocking drug, for example, into brain cells where it keeps the microtubule processes from going awry. The ultrasound may also accelerate the reaction of the drug with the incipient filaments of plaque as by accelerated attachment or accelerated penetration into such mature or incipient filaments or tangles.

The preferably symbiotic drug/ultrasound relationship may also or instead be used for the third process wherein perfusion and diffusive transport in general is improved, or a drug which helps neural recovery or regeneration is driven into regions of interest and possibly has its reaction accelerated by the acoustic (or perhaps resulting thermal) energy. We have mentioned nerve growth factors (NGFs) and stem cells as therapeutic “drugs” in this vein.

The present invention does not require the employment of all three processes, but will frequently include at least the first breakdown process or the second interference process. The third process, aiding local and/or adjacent affected brain cells or function, would typically be used in combination with at least the first process or at least the second process. The second and/or third process, if utilized, may also be mainly drug based wherein any ultrasound acceleration is via faster reactant perfusion (transport) to a reaction-rate limited site as opposed to a faster reaction rate at the reaction site. The first breakdown process is expected to generally be truly symbiotic in that the drug will act faster than if no ultrasound were used. Note that one or more separate therapy sessions may be conducted and that one or more of the same or different of the three mechanisms may be used together or separately within each such session. One could have each session dedicated to a rotating different mechanism for example, or could have each session deliver the same set of multiple mechanisms. The choice of mechanism is expected to also depend on the patient's disease state and prior therapy progress if any.

In general, the patient will either have had a diagnostic image taken ahead of time or will have at least a plaque-burden assessment done without an image wherein a physician looks at a lab-test, for example, a spinal fluid, skin, blood or urine lab-test. In the case of not using an image, the physician may, based on the lab result and/or a database of prior patients, use statistical techniques to estimate the distribution of the plaque burden and/or plaque location. There is expected to be a degree of predictability using such a database, and combined with our relatively gentle therapy, it can be used, with proper care, without fear of damaging good brain matter.

With the above information and any other usual and customary clinical data made available for neurological patients, the physician may choose a particular therapy delivery scheme and schedule/program therapy to be performed using the invention. The preferred therapy, unlike radiation for cancer treatment for example, can be delivered in larger than necessary doses without permanently harming healthy tissues both because the acoustic energy levels are low and because the preferred plaque breakdown process is highly selective due to the use of a drug that (preferably) specifically acts selectively upon the plaque.

Before getting into specific drugs or acoustic arrangements/parameters, we shall now outline a few example treatment sequences as follows:

### EXAMPLE 1

### Patient Showing Initial Signs of Alzheimer's Processes

The tests and treatment sequence are as follows:

Pre-Therapy lab-test(s) indicate early Alzheimer's processes active, low burden;

Session 1 (interference with amyloid formation using a drug plus ultrasound);

Lab-Test(s);

Session 2 (interference with amyloid formation using a drug plus ultrasound);

Lab-Test(s);

Session 3 (interference with amyloid formation using a drug plus ultrasound);

Lab-Test(s); and

Continued drug therapy for interference and/or breakdown and/or peripheral cell benefit.

This first example shows a patient whose pre-therapy lab-test(s) indicate a very early stage of undesirable plaque formation. Herein, it is decided that the undesirable plaque processes must be stopped/slowed (interfered with), but the current light-plaque burden does not necessarily need to be physically removed, at least not immediately removed. Thus, three one-hour therapy sessions using the system of the present invention in its interference mechanism mode are conducted preferably on three separate days or occasions (3 hours total for all delivered treatments), each followed by another lab-test(s) to check progress and to spot any side-effect problems, if any. Each of the sessions is of the process 2 type, involving interference with the plaque-forming process itself. After three sessions, all intended targets in the patient's brain, including any relatively impermeable plaque or fibril materials, have been dosed with the interfering drug with the help of the ultrasound exposure driving drug diffusion into the plaque or incipient plaque deposits. Continued therapy using only a drug (of the interfering and/or breakdown type, for example) can now keep up with or stop the undesirable amyloid processes. Any plaque that did exist may optionally, if necessary, be “tied up” at least on its surface if not also throughout its bulk with respect to its continued growth. This may not be necessary if all plaque deposition processes are halted. Note in this example the interference drug used during the ultrasound sessions is at least diffused into the plaques with the aid of the ultrasound, if not also given activation energy to react by the ultrasound. Needless to say, the drug has also saturated healthy or stressed cells and intracellular spaces such that any residual plaque-deposition processes are being interfered with.

### EXAMPLE 2

### Patient Showing a Significant Plaque Burden

The tests and treatment sequence are as follows:

Pre-Therapy lab-test(s) indicates ongoing deposition processes and significant burden;

Pre-Therapy fMRI to establish plaque burden extent and distribution, functional losses, and any possible impediments to acoustic penetration;

Session 1 (breakup of amyloid plaque using a drug plus ultrasound);

Lab-Test(s);

Session 2 (breakup of amyloid plaque using a drug plus ultrasound);

Lab-Test(s);

Session 3 (breakup of amyloid plaque using a drug plus ultrasound);

Lab-Test(s); and

Continued drug therapy for interference and/or breakdown and/or peripheral cell regrowth and recovery.

This second example depicts a patient whose pre-therapy lab-test indicates an advanced stage of plaque formation and so it is more thoroughly assessed using an fMRI and/or MRI brain scan. It is decided that at a minimum the considerable deposits need to be physically degraded, interrupted, and possibly tied-up (from the point of view of further growth), if not outrightly eliminated. By degraded and interrupted, we mean broken up to an extent that regeneration of healthy tissues is possible or such that toxicity offered by existing deposits is eliminated or suppressed. In any event, at least some prior deposit is likely to be removed in many cases, but removal may not be medically advisable in some cases and the system of the present invention offers the breakup process as an option on its menu. It is vital to understand that the “breaking up” is enabled by the invention; that is, after the ultrasound exposure, further breakdown will continue under the influence of the driven drug. In fact, most of the volume % reduction in plaque may happen as a result of the therapy AFTER the patient walks out of the clinic. Again, this can be attributed to the lasting plaque damage or cellular effects of a past ultrasound exposure. This temporarily lasting damage invites continued accelerated drug interactions.

We do not claim particular lab-tests as best. Our point is that at least between sessions using our invention that a relatively simple (non-MRI or fMRI) test can monitor progress. Preferably, this is not an imaging test simply for cost reasons. We expect many more types of spinal fluid and other bodily-fluid tests as well as optical spectroscopy tests and even skin tests to be developed beyond those being researched now and described in the many known prior art references to further drive costs down.

Another aspect of the prior art references is that frequencies much above 1 to 2 MHz are avoided because attenuation becomes high and deep penetration cannot be achieved through tissue, and especially through even thin bone. It is also more difficult to cavitate at higher frequencies for that prior art which utilized cavitation. The present inventors specifically include in the scope of their invention the use of skull/transducer/helmet thermal-management techniques involving one or both of: (a) delivering acoustic power at less than 100% duty cycle, and/or (b) providing passive or active cooling, which keeps the skull and/or transducer temperature lower than it would otherwise be at a given average power level. This allows the use of higher frequency ultrasound than can normally be considered. Thus, we preferably monitor skull temperature (or a nearby brain or external transducer temperature) and control power to prevent unacceptable skull/brain temperatures. In this manner, the present invention may thermally manage itself or its duty cycle or its frequency-selection to avoid reaching damaging or uncomfortable temperatures in the patient, in the helmet or in therapy system itself. Thus, for example, the system could implement the fastest possible therapy which can be delivered at a given frequency yet not exceed a set maximum temperature of 40 degrees centigrade in any patient's head anatomy.

It is expected that certain plaque arrangements may be broken down faster at higher frequencies for a given at-plaque power-level if the ingoing acoustic wave has a wavelength more toward the dimensional scale of a fibril or fibril-fiber, for example. Thus, 3 to 5 MHz ultrasound has few micron wavelengths closer to fibril/fiber length characteristic dimensions, for example. This approach can maximize local acoustic stresses, such as shear stresses, imposed on the target fibrils, deposits or nodules. Such ultrasound could be delivered through the skull as long as the power duty-cycle and the cooling can maintain a tolerable temperature. Such cooling means may also be used to subcool or precool the skull and/or brain.

Before discussing the hardware and software in the Figures, we shall now list some of the many types of drugs for use with one or more of the aspects of the invention, particularly for use with processes or mechanisms 1, 2, and 3 of breakup, interference and regrowth/perfusion/diffusion. These drugs and drugs under development relate to recent and current Alzheimer's research programs sponsored by the Alzheimer's Association. In many cases, the drug is being considered for a particular mechanism such as process 2 interference with beta-amyloid formation and in others the drug is expected to have more than one process benefit (for example, breakdown AND interference). These are not limiting to the present invention. Note that most or all of these can migrate across the BBB without the aid of acoustics. Thus, we have the application of:

Drugs or drug functional-mechanisms for interference or breakdown of beta-amyloid or its processes or recovery/regrowth of affected living cells

Acetylcholine boosting (Levey, Emory Univ);

Acetylcholine boost by blocking acetylcholinesterase Gue, N. E. Univ Coll Med, Ohio);

Acetylcholine boost via blocking prostate apoptosis response-4(PAR4) (Gue, N. E. Univ Coll Med, Ohio);

Anti-Bodies that bind with plaque components (Trojanowski and Lee, Univ Penn.);

Anti-cancer drugs for microtubule stabilization (Michaelis, Univ Kansas):

Anti-inflammatories in general (Green, Univ Arkansas);

Anti-inflammatories and cholinergics (Beach, Univ British Columbia);

Anti-inflammatory non-steroidal drugs or NSAIDS (Finch, USC);

Antioxidants such as Vitamin E and Ginkgo Biloba (Josepy, Tufts Univ.);

Anti-Sense Therapy for genetic blocking (Boado, UCLA);

Apolipoprotein to clear amyloid-beta (Fagan, Wash. Univ);

Block fibril aggregation with Chrysamine-G or Congo-Red derivatives (Lee, Univ Penn);

Block presinilin 1 and 2 (PSA-1, PSA-2) (Saura, Brigham Hospital);

Block secretase enzymes that clip APP to amyloid-beta (Lee, Univ Penn);

Block beta/gamma proteases that wrongly clip APP (Sambamurti, Mayo Clinic);

Breakup synthetic chemicals for attacking fibrils (Geula, Beth Israel Hospital);

Cyclooxygenase reduction to reduce cell death (Pasinetti, Mount Sinai Med. Ctr.);

Denepezil (Aricept™) blocking (Lahiri, Indiana Univ.);

Diazepam to block amyloid beta rather than control behavior (Graf, Western Univ.);

Enzyme caspase introduction (Tanzi, Mass General Hosp., Harvard, Boston, Ma.);

Estrogen-which appears to have anti-inflammatory properties (Green, Univ Arkansas);

Estrogen patch delivery (Newhouse, Univ of Vermont);

Estrogen and Androgen treatments (Saldanha, UCLA);

Estrogen and Neurotrophins for cell repair (Toran-Allerand, Columbia College);

FynSH2 domain ligand introduction (Krafft, Northwestern Univ);

Gene manipulation of apolipoprotein E or ApoE (Mucke, UCSF);

Insulysis-to degrade or clear amyloid beta (Hersh, Univ Kentucky);

Manipulation of endogenous neural precursors (Macklis, Harvard);

Microglia suppression via neurotoxin reduction (Giulian, Baylor college of Medicine);

Neprilysin-to degrade or clear amyloid-beta (Hersh, Univ Kentucky);

Neurosteroids such as DHEA or DHEAS for cell growth (Mellon, UCSF);

NGF or nerve-growth-factor introduction (Longo, Va. Med. Ctr. of San Fran., Calif.);

NGF for cholinergic basal forebrain (Thal, Va. Med Ctr, San Diego, Calif.);

NGF gene therapy (Peterson, Salk Institute);

Norepinephrine chemical messenger introduction (Harrell, Univ Alabama);

Plasmin enzyme to protect nerve cells from amyloid-beta (Estus, Univ Kentucky);

Tacrine (Cognex™) blocking (Lahiri, Indiana Univ.);

Tacrine (Cognex™) blocking as seen by PET (Lowe, St Louis Univ.);

Transglutaminase to inhibit tau tangling (Muma, Loyola Univ.);

Triterpenoids introduction (Sporn, Dartmouth);

Vaccines stimulate an immune response against amyloid-beta (Lee, Univ Penn.);

Vaccines stimulate an immune response against amyloid-beta (Lemere, Brigham Hospital).

We now list some imaging and lab-test tools for identification and quantification of Alzheimer-related potential, processes or damage. Many of these relate to the taught MRI imaging and spinal fluid sampling techniques. These are not limiting to the invention.

Amyloid-Beta/Tau plaque-imaging and other lab-tests for Alzheimer's, the latest research teaches the use of:

fMRI for functional impairment imaging (Thulborn, Univ Pittsburgh);

Gamma camera with isotope dyes to monitor amyloid growth (Maggio, Univ. Cincinnati);

Optical Laser Spectroscopy through temporal lobe (Kowall, Bedford VAMC);

PET or SPECT imaging using benzothiazole dyes (Klunk, Univ Pittsburgh);

Radio/Fluorescent PET Imaging of amyloids using FDDNP contrast dye (Small, UCLA);

Skin Test (Trabucchi, Univ Rome);

Spinal Fluid, cerebral spinal fluid assess F4 neuroprostane (Montine, Vanderbilt Univ);

Spinal Fluid, cerebral spinal fluid assess for protein-tau (Wilson, Harvard);

B. The Figures.

Beginning with FIG. 1, a flow chart of some possible therapies for delivery using the present invention is depicted. The familiar three processes of breakup, interference and aiding are shown as steps 5, 6 and 7, respectively. Step 4, drug therapy, is meant to include any drug administration (or activation) which is done during the patient's visit or session(s). This is as opposed to advance drug therapy 3, which is drug treatment or administration delivered before the acoustic session. At the top of FIG. 1, one will note step 1 lab-test and step 2 imaging test. The purpose of these test(s) is to determine what therapy the patient requires. By what therapy we mean which process steps (e.g., processes 1-3 or steps 5, 6, 7 as depicted) and/or which drugs (steps 3, 4, 10). So, for example, a patient with incipient plaque deposition but negligible current plaque burden might be identifiable using only a lab-test 1, for example, a spinal-fluid or blood-test. A patient with a lab-test 1 indicating a significant burden may be further imaged using fMRI or MRI item 2 looking for either functional losses or physical losses. Ideally, one can avoid the routine use of the imaging step 2 from a cost perspective; but the patient's risk/welfare should always be the final determinant of this. Another reason for doing imaging step 2 is that if a plaque burden exists, then it may be beneficial to know its distribution such that simple adjustments or adaptations of the treatment hardware and software can be applied. One such adaptation, for example, could be the selective loading (or excitation) of particular therapy-helmet transducers at specific skull locations or direction of one or more transducers at specific angles. Another could be the customized or selective powering of such one or more transducers, or the selective delivery of drugs to such affected regions by any means. We regard these as setup items. We emphasize that FIG. 1 depicts a therapy “session” which typically includes at least one step from the group of steps 5, 6, and 7 combined with at least one drug step from the group of steps 3, 4 and 10. Before the actual acoustic session, we expect at least one test, preferably, a lab-test 1. Sometime after the session, we preferably expect a follow-up lab-test 8 to ascertain progress. This test may occur immediately thereafter, or a fixed time thereafter. Again, we show an optional imaging test 9 after the acoustic therapy. If imaging 2 were done, it is likely that imaging 9 would also be done for comparative (progress) study at a later time, perhaps on a later day. Again, particularly for patients with significant plaque burdens or obvious functional and behavioral losses, imaging may be frequently utilized. We also show a post-drug therapy 10 (post-session) wherein the patient is kept on a medicament or drug for a period after the acoustic session, perhaps on long-term maintenance to prevent plaque-deposit or process reappearance. Obviously if the patient undergoes multiple separate sessions on different days, then drug 3 and 10 may be the same drug.

Most of the time, the patient will undergo at least one of 5 (breakup) or 6 (interference), perhaps in combination with 7 (aiding). It is also expected that the inclusion of at least one lab-test (1 and/or 8) and a post-drug therapy 10 will be utilized.

We emphasize that the drugs or medicaments of steps 3, 4 and 10 need not be the same drug or a single drug. For example, the drug of step 3 may enable the following ultrasound-aided breakup 5, while the drug of step 4 (if used) simply suppresses any possible inflammation due to the acoustic waves themselves. Finally, the post-therapy drug 10 may be chosen to serve as an interference drug that chemically or genetically blocks plaque processes as opposed to dissolves plaques. Any of these drugs may be a cocktail mix of several such drugs. Any of these drugs may be delivered in a contrast agent or may be administered in any conventional drug-administration manner as taught in many of the references and are known to the medical arts. Any drug-bearing contrast agent may release its drug of its own accord or may be arranged to release such drug(s) via the effects (e.g., acoustically-aided diffusion, cavitation, heating, streaming, etc.) of an acoustic illumination, for example, the acoustic exposures 5, 6 or 7. We remind the reader also that a patient may be scheduled for several separate sessions (times passing through at least one of the processes of FIG. 1). As an example, consider a session 1 that emphasizes step 5 breakdown, a second session that emphasizes interference 6 and a third session that emphasizes aiding step 7. Furthermore, we emphasize that delivering, for example, a breakup (step 5) or interference (step 6) process may result in some aiding benefit (step 7) even though such aiding was not targeted in an isolated manner. We also include in the scope of the invention the process wherein a patient is moved through the steps of FIG. 1 multiple times within a single session, for example, a session wherein a process sequence of steps 5, 6, 5, 6, 5, 6 or 4, 5, 6, 4, 5, 6 or 4, 5, 4, 6, 4, 7, 4, 5, 4, 6, 4, 7 is delivered.

The prior art lists but a few examples of currently pursued drugs that may be used with the invention. We also expressly include antioxidants, hormones, vitamins such as E and C, antibodies and prodrugs (per U.S. Pat. No. 6,028,066 to Unger) taken in any form, which are generically now thought to be beneficial against plaque-forming processes. Also included are cases wherein one such drug is or incorporates a contrast agent, such as a microbubble agent, useful for an imaging step such as steps 2 or 9 and cases wherein the drug is a disease-targeted drug as for example per the known art.

We also include in the scope of the invention wherein a lab-test is done in real-time or at least is done once during a session (not shown being done during acoustic treatment), such that the outcome of the lab-test may be used to either automatically or manually provide in-session-related feedback to the inventive systems operation. Recall that we intend such a lab-test to include all manner of non-invasive and semi-invasive spectroscopy or skin-sensor types of feedback, particularly, and, preferably, patient-monitors not requiring renewed bodily fluid samples to be taken. At lesser convenience, bodily-fluid samples could also be utilized with the invention. Ideally the inventive system monitors such feedback and can react to it automatically to minimize required supervision of the therapy.

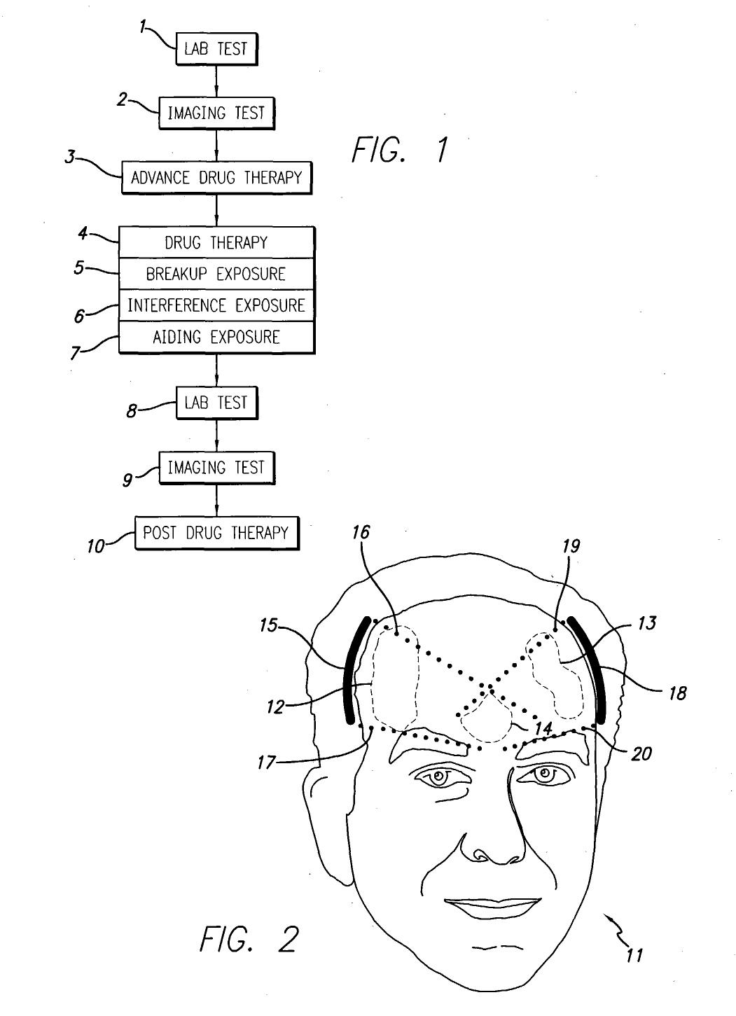

Moving on now to FIG. 2, therein is depicted a patient's head 11 having two therapeutic acoustic transducers 15 and 18 delivering acoustic energy into and through the patient's skull and brain. The first important note is that although we have shown only two transducers, and these are on the sides of the head, we anticipate the optional use of transducers at all (or any one or more of) locations on the skull that offer access to the AD-affected brain regions such as those we previously described. So two different patients may have two different sets of transducers located on their skull, differing in number and/or locations. Going back to FIG. 2, three regions of targeted treatment are shown inside the patient's skull as regions 12, 13 and 14. Such targeted regions might, for example, be selected for any one or more of the three processes of breakup, interference or aiding delivered in one or more sessions as previously described. It will be noted that acoustic emitter 15 has emanating acoustics largely defined by the region between the dotted lines 16 and 17. The acoustic emitter 18 has emanating acoustics largely defined by the region between dotted lines 19 and 20. It will further be noted that in FIG. 2, the targeted region 12 is primarily being treated by emitter 15, the targeted region 13 is being primarily treated by emitter 18, and the targeted region 14 is being treated by one or both of emitters 15 and 18 as it sits in an overlap region. The transducers 15 and 18 are shown closely situated with the skull. The small gap underneath the transducers would be filled with acoustic-coupling material (not shown), such as a coupling gel, couplant standoff, or a liquid-filled or liquid-saturated bag or membrane. Ideally, such couplant would be contained as by a membrane or a wetted-sponge material; however, we include in the scope of the invention the couplant being a film, layer or body of liquid (e.g., water), gel, paste or cream similar in nature to an ultrasound imaging gel known to the art. We also include in the scope applications wherein the transducer(s)/skull gap(s) are filled by a flowing liquid (such as cooling tap water) or an immersion liquid (as by immersing the helmet in a liquid container). We also anticipate the possibility of trimming, cutting, bundling or otherwise controlling the patient's hair. The most likely measure would be saturation of any existing (or untrimmed) hair with a liquid or gel couplant.

We wish to draw attention to the fact that the transducers 15 and 18 shown are weakly focused. By weakly focused we mean that significant acoustic gain is not required in order to achieve the therapy. While we do allow beams to overlap such as those from transducers 15 and 18 at plaque location 14, one can see that neither is strongly focused (to a point) even at that depth. This approach has several advantages. The first is that most or all scanning of beams can be avoided. The second is that acoustic dose vs. depth is far more uniform than for a fine focus and a high-gain. This allows treatment of large regions without worrying about attaining an “enabling power” at a focal point. Processes 1, 2, and 3 (FIG. 1, items 5, 6, 7) are optimally arranged such that diffuse focus beams as shown are useable and that most or all regions within such beams have sufficient energy to enable the process 1, 2 or 3, but insufficient energy to worry about an overdose in the form of an unintended cavitation event or a hot spot causing necrosis or permanent cell-damage. Thus, preferably, the user of the system would involve emission modes comprising continuous wave (CW) emissions delivered in gated multiwave pulses or delivered continuously. Pulsed modes of operation would preferably be utilized mainly for process 1 (breakup) wherein such breakup is that of a drug-weakened plaque structure, so modest gated CW pulses or continuous CW energy will suffice. Gated CW pulses may each have from 1 to thousands of waveforms, for example. Typically they will have from tens of waveforms to a few thousand waveforms per pulse. For example, a ten microsecond pulse of 1 megahertz acoustics delivers ten waveforms. Sessions that contain only CW algorithms are included herein by the inventors, as are sessions wherein breakup is done with continuous CW+CW pulsed waveforms or by only pulsed CW waveforms. Processes 2 (interference) and/or 3 (aiding) are most frequently done with low-power CW algorithms with continuous CW or at least many-wavelength CW pulses. Therapy sessions are expected to involve minimal temperature rise in living brain matter, certainly below the necrosis region above approximately 43 degrees C. for any significant time. By significant time we mean at least an accumulated tens of seconds typically. Higher temperatures may be experienced in acoustically lossy plaque material portions. On the other hand, a few degrees rise (say to 40 degrees C.) may be utilized to further thermally activate a drug or drug-related process. The broad beams are ideal for such slight and broad heating of large regions as well as of slight selective heating of highly-lossy plaques buried in a lower-loss cellular ambient. Note that if slight sustained heating is needed in the presence of blood perfusion to accelerate the action of a drug, then a broad static beam is the only practical way to do this. Although we show emitters 15 and 18 of FIG. 2 being slightly spherical (curved in sections shown) roughly matching the curvature of the head, this is simply to reduce the total thickness and weight of the helmet or headgear supporting the emitters. Emitters such as 15 and 18 could also be flat transducers that are coupled to the curved skull via a shape-adapting couplant layer as previously described. Curved skull-following emitters have the advantage of introducing the acoustics perpendicular to the skull and minimizing reflections and mode conversions. The goal is not attaining gain. Flat transducers are cheaper to build and mount. One may alternatively do slight focusing (as depicted) using a lens (not shown) rather than mechanical curvature of the transducer itself (shown).

Preferably, emitters 15 and 18 are piezoceramic or piezopolymer transducers driven electrically. However they may be any type of acoustic emitter, i.e. piezoelectric, magnetostrictive, electrostrictive, optoacoustic, electrostatic etc., or even the delivery end (output port) of an acoustic waveguide. The design and fabrication of such transducers is widely known in the art. Ideally, the transducers are abutted or spaced across the helmet such as a pattern of close-packed hexagonal emitters would be. Ideally, the helmet which holds or aligns the acoustic emitters, can be fitted with emitters in any one or more prefabricated mating holes or mating mounting means. In other words, the transducers either fit into receptacles of fixed position or are arranged to attach at any desired point on the helmet, headgear or headframe (helmet not shown in FIG. 2). We include in the scope of the present invention a helmet which has such receptacles as well as a helmet which is acoustically transparent such that the transducers are surface mounted to the helmet inside or outside (outside: requires acoustic transparency) of the helmet. We also include in the scope of the present invention a helmet and mating transducers which have built-in mating electrodes such that no stand-alone connectors need be handled when loading the helmet with an appropriate transducer subset or set. Also, we expect that custom-fitted helmets may be molded in place just like some ski boots are molded onto the foot to get a perfect fit. Such helmet-making processes would still allow for the placement of standardized transducer receptacles therein. One might even fabricate the entire helmet out of an acoustic emission material.

We also include in the scope of the present invention the use of a monitoring or listening hydrophone or transducer such as a needle-type receiver hydrophone inserted into the brain, preferably via a vascular or ventricular lumen. The idea is that one may measure the actual strength of acoustic excitations coming from each external therapy transducer. One could easily implement a feedback loop such that the hydrophone receiver controls system power delivery, particularly to account for anatomy variations, disease states, transducer variations or the change in amounts of plaque present. One could also easily pulse the hydrophone and have it emit a weak signal which is in turn detected by the therapy transducers operated in a receive mode. This would also give information about the anatomy in front of each transducer. One may also transmit from a first therapy transducer and receive from one or more other therapy transducers to also deduce something about the anatomy or system setup and operation. An advantage of this latter method is that it is noninvasive. By “transmit” herein, we mean either pulse or CW transmission. We also expect the use of network connectivity for the therapy system such that its use or condition can be controlled and/or monitored remotely. This would be highly beneficial for home use for example. The system may also be capable of applying time or phase delays between the firing of individual transducers or transducer elements. This would support the prior-stated preference to be able to modestly steer the peak power position within the tissue or to make sure any gaps between transducers are treated. Again, we emphasize that we prefer to treat as large a volume of tissue at a time as possible for throughput reasons and because a diffuse large focal area is acceptable for this, whether it is steered or not. Our most preferred arrangement has multiple closely-spaced transducers that are weakly focused such that they statically (without steering) collectively illuminate all the brain tissue in front of them. Such a helmet may have transducers covering its entire surface. A last variation would incorporate slight steering of the collective acoustic radiation solely for the purpose of improving uniformity such as between transducers. The attenuation of the beam versus depth for each transducer can be affected by varying the output frequency in a known manner. Doing this one could have a particular transducer treat only near-in tissues (at higher frequency) or treat tissues all the way to the opposite side of the skull (at lower frequency). Current-day radiation treatment (oncology) equipment utilizes 3-D dosimetry and such software could also be used for ultrasound brain therapy planning and/or control.

Before we get to the next Figure describing the system architecture, it is appropriate to discuss cooling, which is a key and beneficial optional attribute of the present invention. We specifically incorporate cooling in one preferred embodiment because it offers several key advantages. By cooling, we are talking about removing heat from the head, the helmet or the transducers therein or thereon. We mean making arrangements for such cooling to be encouraged as by passive thermal sinking (heat spreading), free-convection, and/or active cooling (using a flowed-gas or liquid-coolant). In a preferred embodiment, the acoustic couplant layer is water-filled membrane material and that water is thermally coupled, directly or indirectly, to the skull (inwardly) and to a small heat exchanger outwardly. Such a heat exchanger might, for example, simply consist of a small high-performance CPU fan known to the art, which pulls (or pushes) air past a set of metal fins in a duct that is thermally fin-coupled to the water membranes. Such ducting could be just a few millimeters tall and quite wide. Alternatively, we include in the scope of the present invention all manner of forcible cooling including (a) a flowed gas such as air, (b) a flowed liquid such as water (whether circulating or non-recirculating), (c) the use of Peltier or Seebeck-effect thermojunctions which are solid-state devices which pump heat across a set of doped junctions, (d) the use of phase-change materials which suck up heat at a fixed phase-transition temperature, (e) The use of a coolant which must be loaded for each session, such as an ice-water mixture, (f) phase change cooling such as evaporative cooling of water, (g) the use of cool tap-water which is directed down the drain after one or more passes through the helmet or the use of heatpipes or evaporators.

We have mentioned that as frequency goes up the attenuation and therefore heat generation also goes up. This is particularly true for skull-bone wherein frequencies above about 2 Megahertz become very highly absorptive in bone. Our system allows for the bone and/or the transducers to be cooled such that higher frequencies are useable and such byproduct heat can be removed. Advantages of such higher frequencies are shallower dissipation in target tissues and an ability to impose more disruptive shear-stresses on microparticles of plaque having dimensions comparable to the wavelength. Such heat removal means may cool the skull bone directly or indirectly to keep it and its underlying tissues below a set temperature such as 40 degrees C., for example. The system could also incorporate a feedback loop between the application of the cooling (via temperature measurements) and the application of therapy (heating) power. A maximum temperature or a desired set temperature may be inputted.

The last aspect of FIG. 2 we wish to elaborate on is that a transducer such as 15 or 18 will excite waves in the skull at the periphery of such transducers 15 or 18, in addition to the waves directed inwards directly underneath the transducers. Practitioners of the acoustic art know that such peripheral edge emissions can act as a virtual source of energy and that if such transducers can be arranged to be closely spaced enough, then one can get away without having blank regions of emission in such small remaining gaps. In addition, if a frequency of an operating transducer 15 or 18 is a characteristic frequency of the resonant skull itself, then such “edge effects” can be very large and be present directly under the transducer as well. We include in the scope of the invention wherein one or more transducers is operated at a frequency that drives a resonance in the patient's skull. Two examples would be a primary spherical mode of the entire skull, which has been reported to be about 13 hertz and a natural frequency of a skull thickness, which is in the kilohertz range. Likewise, multiple such transducers 15 and 18 could be phased in cooperation in a way that amplifies and reinforces such whole-skull waves, which can literally be driven around the skull in circles. These modes are in-plane modes as opposed to thickness modes as is well known to acousticians. More commonly, excitation frequencies will be optimized for maximizing the effects of a process 1, 2 or 3 rather than maximizing a skull resonance. In any event our point is that the skull may itself be excited into resonance modes and that vibrational energy may resonate portions of the skull away from the immediate transducer. Naturally, any and all skull vibrations will leak inwards into the brain, in part, and contribute to therapy. Thus excitations of the skull may be regarded as helpful if the frequency content is useful for therapy. The most preferable application has most of the acoustic energy going directly through the skull from the above-lying transducer with the intervening skull vibrating across its thickness, whether it is a resonant skull thickness or not.

C. Power/Frequency Discussions.

The inventive system utilizes relatively low power-intensities or densities as low as on the order of magnitude of diagnostic ultrasound imaging. Such low-power densities, especially in single-pulse or few-pulse non-CW modes, cause small temperature rises (a few degrees C or less) far far lower than an ablation system wherein the temperature rise needs to be 50 to 100 degrees C. above tissue-ambient for at least a very short period. Our approach is in keeping with the avoidance of direct unaided thermal tissue damage and allowing for a broad macroscopic focal region where coverage rather than power density or gain is the primary goal.

Low acoustic power densities are generally in the range of a few milliwatts per cm² to 10 watts per cm². Depending on how long such an illumination is switched on, the tissue will be warmed. For short times (millisecond to a few seconds range ultrasound pulses), the lower power densities above will raise the tissue temperature less than a few degrees C during one such pulse, which will avoid tissue thermal-damage, known to happen around 43 degrees C. and above.

In terms of frequency, most aspects of the invention will work over broad ranges. For example, any emission between 1 hertz and 2.5 megahertz will penetrate the skull appreciably. Because we incorporate cooling in the invention, we can tolerate some losses (heat generation) in the skull itself, something that no prior art system can tolerate because this would raise the overall brain temperature and remove any operating margin. In any event, in the sub-megahertz range, cooling would probably not be required (low duty cycle and minimal attenuation would keep things cool enough) whereas in the 2 to 5 megahertz range and above, it would be preferred. In between, one has a tradeoff of using cooling or reducing power or duty cycle of the emissions to generate less heat per unit time. An advantage of cooling is that one can do a faster therapy and one can utilize frequencies that have characteristic wavelengths on the order of the feature size one is trying to disrupt. This generally translates into improved energy coupling into the target, a fibril, for example.

We include in the scope of the invention both pulsed and continuous wave operation (CW operation). CW may be delivered for a finite ON period, typically from milliseconds to tens of seconds. We also include in the scope of the invention chirped operation and multitone or broadband operation (known in the acoustic arts) as well as customized operation for a given patient's skull/brain anatomical system. CW operation may also be arranged to be pseudo-CW operation in order to suppress cavitation, as is known to the art. Pseudo-CW means that the CW frequency varies with time somewhat so that inertial cavitation is suppressed.

In general, any acoustic emission cycle which avoids most or all of the following may provide benefit using the invention: (1) avoid more than about a 5 degree temperature rise in significant quantities of living brain cells to avoid necrosis or direct thermal cell death of any type, (2) avoid direct unaided (inertial) cavitation at least during CW pulses wherein the cavitation on-time will be very large and the damage accumulates quickly, and (3) avoid high peak acoustic pressures above 7 megapascals, especially in CW operation.

So to provide some specific application examples consistent with these goals we have:

(1) A breakup process preferably using a breakup drug and an emission of 1.5 megahertz, 1 second CW pulses, 20% duty cycle at 1 watt/cm² acoustic power;

(2) A breakup process preferably using a breakup drug and an emission of 1 megahertz, millisecond-period few-cycle pulses, 1% duty cycle at 10 watts/cm²;

(3) An interference process preferably using an interfering drug and an emission of 500 khz, 3 second CW pulses, 10% duty cycle, 0.75 watts/cm² acoustic power;

(4) An aiding process preferably using an aiding drug and an emission of 2.0 megahertz, 0.5 second CW pulses, 20% duty cycle at 2 watts/cm²; and

(5) An aiding process preferably using an aiding drug and a broadband emission centered at 1 megahertz, 10 second pulses, 25% duty cycle, 0.35 watts/cm².

Higher power densities can be used at the expense of even shorter pulse lengths and lower duty cycles. Cooling may also be required.

It will be recalled that we wish to avoid direct unaided or inertial cavitation, which will certainly have started to happen in tissues in the 2000 to 3000 watts/cm² range at 1 to 2 megahertz and is a highly unpredictable and uncontrollable phenomenon. Such power densities in bone are far too high and would cause severe burning of bone for any appreciable pulse length. Widely known in the acoustic arts is that by employing microparticulate agents such as microbubble contrast agents or certain surfactants, one can dramatically reduce the power necessary to induce cavitation, and can reproducibly cause controlled cavitation at the site of each such microbubble. This is referred to as aided cavitation. Thus one may employ a microbubble agent, for example, which can be cavitated or locally oscillated such that it mechanically contributes to the erosion of a plaque particle or deposit. The microparticulate of microbubble may also release a drug payload via leakage or rupture, the drug being a drug(s) of the invention herein. The power density to cavitate microbubbles or to at least energetically oscillate them is more in line with the power densities taught above for use with the system (watt to tens of watts range). In a more specific example, one may introduce a contrast agent or microparticulate into the vascular system that molecularly targets AD neural plaques. After the agent has chemically attached to the plaque, ultrasound is introduced, which causes the contrast agent bubbles to resonate on the plaque, providing high-energy erosion of the plaque, possibly in addition to drug-related breakdown mechanisms. Note that we use the term “contrast agent” as it is in the vernacular, but our agent may serve no imaging function whatsoever. Assuming the targeted attached agent only coats plaques then the adjacent damage to healthy tissues may be minimized.

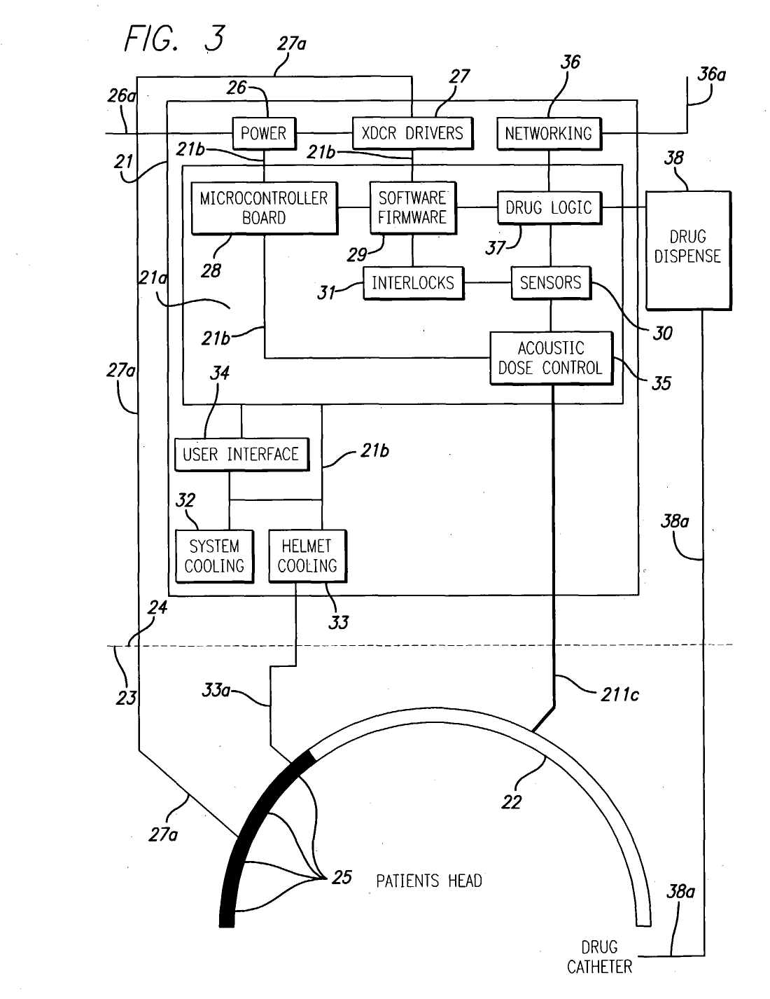

Turning now to FIG. 3, we see in schematic diagram a helmet 22 equipped with closely juxtaposed transducers 25, which is connected to a therapy system 21. Smaller and identical transducers 25 have herein replaced the dual larger transducers 15 and 18 of FIG. 2. Although the helmet 22 is not shown on a patient, we note in FIG. 3 that the “patient's head” would fit therein. Shown connecting helmet 22 to system 21 are a variety of cables and lumens including: transducer driver cable 27a, helmet cooling cable and/or lumens 33a, and data bus and power cable 211c. Note the phantom line 23/24 across the cables. The upper half of the Figure, indicated by 24, is the system components section, and the lower half of the Figure, indicated by 23, is the helmet half of the system. Note especially that the cables running across the phantom line may have any desired length and may allow freedom of motion of the patient/helmet relative to system 21.

First, we state that we do not favor a particular cable design or cable strategy as to which services are provided by which one or more cables or lumens or cable jackets therefor. We have shown these separately simply for pictorial simplicity. For a portable system as we have defined it, it would be preferable that the cable(s) 27a, 33a, and 211c can be easily plugged and unplugged from the helmet 22 such that different helmets of different design can be used as well as allowing for a helmet to be loaded with multiple transducers 25 separately from the system itself. We also wish to emphasize that for our preferred portable application, a free-standing helmet 22 (shown) is preferred such that the patient can sit or recline free of any bulky and inflexible therapy device that contains its own fixed headgear or attachment arms. Ideally, the system console 21 would be placed bedside or seatside. Although we have indicated cooling services for helmet 22 being carried by the cable 33a, what we mean to emphasize is that such services might take several forms. In a simple form, the cable 33a would only deliver electrical power to cooling means in the helmet 22 such as to a ducted air-fan and/or liquid-pump (not shown) within the helmet. In a more complex form, the cable 33a would be pumping cooled coolant to the helmet 22, wherein the refrigerator or cooling device is located in the system console 21. In the preferred embodiment, we prefer not to have any liquid connectors among the cables 33a, but for a high performance system 21/22 requiring hundreds of watts of cooling (e.g., a high frequency system with low electroacoustic efficiency), this may be necessary.

Moving now to the contents of system 21, let us begin with power supplies 26 which are fed from a power receptacle (not shown) attached to power cable 26a. Power supplies 26 represent any and all power, usually electrical in nature, that is required to operate the system or deliver the therapy. It could include any CW or pulsed power supplies for activating transducers singly or in cooperative or timed unison, as well as any AC or DC supplies needed for circuit boards or related peripherals of system 21.

Transducer drivers 27, shown adjacent power supplies 26, may include any switching, amplification or phase-delay hardware/software utilized to fire the transducers singly or in timed-unison as well as any matching networks which improve electrical coupling efficiency. Electrical and logic connections are shown connecting items 26 and 27. Also shown are transducer driving cables 27a running to the helmet 22.

Circuit board 21a is basically a computer that controls and manages the overall system 21/22. It would likely be based on a microprocessor or microcontroller board 28 and would have RAM memory, data, and signal buses of the type 21b shown connecting all of the elements, if not also access to mass-memory (not shown).

Software/firmware 29 is provided as is known in the art to execute the system software at the program level and at the bios-level.

Sensor electronics 30 includes temperature sensor circuits, flow sensor circuits, etc. Preferably, a temperature sensor would be located somewhere in the helmet such that the system 21 could control (via the helmet cooling means 33 or the transducer powering means 27) the thermal ambient of the helmet (or skull) as experienced by the patient or as measured by a temperature sensor.

Interlocks 31 include control-circuit and software safety features such as maximum temperature limit circuits or software, maximum acoustic-power limit circuits or software or maximum acoustic dose limit circuits or software.

System cooling 32 would include any cooling means needed for the console 21 itself, for example, for cooling the microcontroller board 28 or its parent board or module 21a.

Helmet cooling 33 consists of any cooling or refrigeration unit that provides cooled coolant to the helmet 22 through cable 33a, and is more conveniently located in the system 21 if an actual refrigerant unit of any weight or bulk is involved. In the case of the helmet cooling consisting of a helmet fan and duct system, then cable 33a may only supply electrical power and logic to the helmet cooling.

User interface 34 may comprise one or both of a practitioner's (doctor or nurse, for example) interface and/or a patient's interface. In any event, the monitoring and/or control interface 34 would allow the user to, depending on their expertise, to start/stop therapy, to choose which processes 1, 2, 3 are to be run (breakdown, interference, aiding), to choose what CW or pulsing conditions are to be used for each process, to choose or enable which transducers are to be utilized, to choose a maximum temperature setting or to select preprogrammed (or downloaded) algorithms or programs made available on the system. A patient would likely be limited to the start/stop of one complete predetermined or preauthorized therapy session at a time, whereas a remote or present practitioner may be allowed to enter or activate a desirable program based on the current diagnosis.

Item 35 is acoustic dose control. We emphasize that computation of such exposure, given little or no scanning and weak focusing, should be fairly easy just taking into account known transducer geometries, known overlaps of emissions if any, and expected or estimated attenuation vs. depth for the emission algorithms utilized. At a minimum, we include it as a safety feature in the form of an interlock; however, we remind the reader that processes 1, 2, and 3 are preferably of low power and drug-aided such that if dose limits are any concern at all, it is preferable more because of undesired secondary inflammation than because of accumulated sonic damage. In another embodiment wherein at least some higher acoustic power is to be used such as for pulse-fracturing (breakup) plaque bodies 12, 13, 14 or pulse-bursting drug-bearing contrast agents, we would have the dose control 35 actively monitor dose, as the dose delivered therein may be an appreciable fraction of a limiting dose causing unacceptable side-effects.

Networking 36 is connected to board data-buses of the type 21b and any off-board communication channels 36a such as an internet TCP/IP protocol connection, a wireless protocol connection such as WAP 802.11 a/b or Bluetooth or a USB or RS-232 connection, for example. Thus, we expect networked implementations of the invention wherein at least one of the following is allowed:

(1) Remote monitoring of therapy delivered;

(2) Remote monitoring of therapies available on the system;

(3) Remote manipulation of a current or ongoing therapy;

(4) Remote loading/removal of available therapy algorithms;

(5) Wireless coupling of the system to a telephone, network, internet or data recorder;

(6) Wireless (or wired) coupling of the helmet to the console;

(7) Remote authorization for use of the system by a patient;

(8) Remote communication of the fact that a particular therapy was delivered, for billing purposes;

(9) Providing communication between the therapy system and one of the above-mentioned auxiliary devices including: (a) a vascular hydrophone or acoustic emitter, (b) a temperature measurement device, (c) a drug delivery or drug monitoring device, (d) a database containing patient-specific information, (e) a patient image or related targeting or desired dosage information.

By “remote”, we mean a location other than the bedside or patient-side, which could be from a nearby local nursing (or doctor's) station or from a control room in another state or country. It is also expected that one remote monitoring person would be able to look over several such therapy systems 21/22 operating in the field and would be able to shut one system off, thereby overriding everything if he/she has any reason to believe there might be a problem. In our networking feature 36/36a, we also include the option of a two-way (preferably) voice and/or video link between the patient and the remote operator/practitioner/monitor. Such video or audio capabilities may also be utilized to entertain the patient (e.g., television or video presentation to the patient via a head-worn or helmet-mounted display) or relax the patient, or provide a communication means to the patient as for a phone.

Item 37, drug-logic, and item 38, drug-dispense, are provided for applications wherein a drug is delivered, such as drug step 4 and/or 3 of FIG. 1, in a manner wherein there is some kind of feedback loop between the drug delivery mechanism or the drug-level monitor (a realtime lab-test, for example) and the operation of the inventive system. So, for example, one could have the system 21 dispense the drug from means 38 into the patient in the form of an infusion pump 38. A drug lumen 38a is shown running to such a patient drug-catheter (and into the patient, not shown). Alternately, the drug dispenser 38 could physically reside outside system 21 and be a standalone drug dispenser with an interface means such that system 21 and the drug dispenser 38 can communicate in at least one direction across a data bus or network. We note that in order to control the level of the drug in the body, one may detect the drug directly or detect one of its byproducts or effects. So when we refer to a lab-test in realtime, we mean that we have a realtime sensor that monitors an attribute of the drugs activity at least once during a session. We previously talked of realtime lab-tests for monitoring an attribute of the disease and its extent. So realtime during-therapy monitoring may include one or both of drug monitoring or disease-state monitoring and one or both of those may involve a feedback loop with the inventive system 21/22.

We note in FIG. 3 that although the console 21 and helmet 22 are shown as separate assemblies, we expressly incorporate the approach wherein the entire system 21 and helmet 22 are cointegrated in a helmet-like device/system that is highly portable. As an in-between implementation, one could provide some or all elements of system 21 in a belt-hung bag or backpack such that, for example, the patient can ambulate during therapy, if that is safe. Such a belt-hung or backpack system would most favorably utilize rechargeable batteries or fuel cells which can be recharged without battery replacement.

We also include in the scope of the invention the case wherein one or more therapy or other independent transducers 25 in the helmet 22 or in or on the patent is/are utilized in a receive-mode and listens for acoustic signatures or reflected signatures of events such as cavitation (whether desired or not) or a strong echo indicating the location or presence of highly reflective plaque or successfully targeted plaque-blanketing contrast agent. Such reflections may be used to monitor the amount and movement of such plaque bulk and interfaces thereof. Thus, the therapy transducer 25 (or an added independent transducer) becomes a therapy-monitoring transducer at least part of the time. Such an independent transducer could also be a catheter transducer placed within the brain (not shown) and used for at least one of (a) reception from or, (b) calibrated transmission to helmet transducers 25 to deduce path attenuations to each helmet transducer 25.

So, in summary, we have a therapy system 21 and associated system helmet 22 designed specifically for treating deposition-related diseases of the brain using at least one of three taught therapy processes or mechanisms, at least one of which preferably can be acoustically enhanced in rate, extent, completeness or safety. Because of the system's preferred diffuse emissions and drug-enhancement, it can treat large tissue volumes at very low cost with minimal or no expensive phase-delay strategies and using generally low energies. We also have a system 21 that preferably operates in a regime wherein ablative heating and unintended (unaided) cavitation-destruction are avoided. The system 21 and helmet 22 preferably allow for higher-power or higher-average-power operation because of its cooling option 33/33a; thus, therapy time is limited by maximum temperature rise at depth in the brain. The cooling is seen as particularly useful when the helmet is emitting high frequencies and significant bone attenuation-heating or transducer inefficiencies generate heat. The system is preferably portable per our definition and has a helmet design that allows for some patient comfort in a sitting, reclining or laying position. Preferably, the method using the system incorporates pre- and possibly post-therapy lab-tests and/or imaging tests and furthermore utilizes preferably at least one drug 3, 4 or 10 for at least one of pretherapy drug treatment, during therapy drug treatment or post-therapy drug treatment. Preferably, at least one drug of the type 3, 4 or 10 also has its therapeutic action accelerated by, enhanced by or extended by ultrasound during the delivery of one of the three therapy processes in the current therapy session and/or in a following therapy session.

One skilled in the art may alternatively choose to couple the acoustic emissions into the skull in a manner avoiding through-skull transmission. For example, one could inject acoustic or vibratory emissions through the upper and/or lower jaws using a bite-down acoustic mouthpiece containing vibratory emitters. Such emissions would be coupled into the skull above, particularly well for lower excitation frequencies. However, such an approach does not allow for any selectivity as to where emissions are delivered to various plaque deposit regions so such an approach would be much more amenable to very low frequency therapies (hertz to kilohertz ranges) used for total simultaneous brain treatment.

One may also choose to utilize an “incomplete” helmet or partial helmet, which is nothing more than a helmet-portion in the form of a headband, headrest or pillow. Such logical variations are within the scope of the inventive system. Our teaching is for a preferably portable system delivering preferably-selectable wide-region coverage of one or more of three processes. The “helmet” may thus be rested upon or juxtaposed to the head, as opposed to being worn. Thus, it becomes a headrest or pillow, for example. It could also comprise an elastic or fastened headband.

Certain aspects of practicing the invention will become known to the reader given the teaching and these are included within the scope. For example:

(a) MRI, fMRI or CAT imagery could be used in combination with a software program to automatically generate the details of a helmet treatment (which transducers to operate, power-levels, etc.). Such details could be downloaded to a therapy system.

(b) The electrical impedance of the transducers may be used to deduce something about the quality of acoustic coupling to the skull as well as something about changes happening to acoustic properties of the brain materials including plaques.

(c) Therapy may be delivered to patients in a completely preventative mode wherein the patient does not yet show any significant outward signs of AD or AD processes nor of any other neural disease.

(d) We have focused on normal incidence compressional acoustic waves; one may also utilize shear waves with proper coupling.

(e) We have emphasized acoustic coupling to the skin over the skull. One may remove or penetrate the skin (preferably, not the skull) to enhance coupling and reduce losses. Hard contact with skull bone would also allow shear-mode coupling directly. While the system of the present invention may be used with a craniotomy, it is not preferred.

(f) The cooling means may be utilized to subcool the head/brain below 37 degrees C. or so. In this manner, a higher intensity acoustic exposure (or longer exposure) could be delivered and still remain under a given temperature limit, at least in shallower regions in thermal communication with the surface. Such an arrangement would likely utilize alternating treatment and cooling periods. Alternatively, the patient's entire body could be subcooled.

(g) Patients with advanced AD have large sections of brain missing or shrunk. We include in the scope of the invention any means taken to assure the avoidance of the creation of an air-filled pocket in the skull through which ultrasound cannot pass. One such approach would be to semi-invasively deliver a backing fluid through a small hole in the skull or through vasculature into the brain region affected by the gas void or potential void. A catheter could deliver such a volume-replacement fluid or material.

(h) Step (g) above could also serve to assure that the skull/brain interface does not develop a void or unwetted region during therapy.

(i) Transducers mounted in/on any helmet may be vibrationally isolated from the helmet so as not to unacceptably resonate the helmet itself. This is of particular concern for low excitation frequencies in the kilohertz ranges.

(j) Although we have concentrated on piezoemitter-type transducers, the scope of the invention includes any vibrational exciters including, but not limited to, electromagnetic, electrostatic and magnetostrictive exciters, as well as laser-excited optoacoustic emitters and acoustic-waveguide-coupled acoustics.

(k) The patient may be imaged with the helmet on if desired, so as to establish alignment of the transducers with the plaque, for example. Again, our preference is for image-free therapy at least during acoustic exposure.

(l) One may stagger phase delays of our multiple transducers to smear or slightly steer their beams to overlap and fill in any gaps (still at low or no gain, unlike classic beam-forming). This is totally different and much easier to do than to form a fine focus point and move it in three dimensions. One could use a fixed delay algorithm, which would result in a fixed dose map. Note that this slight “wiggling” of the beams is of small magnitude, compared to classic beam-forming; thus, most ultrasound energy hitting a target is coming approximately directly inwards, as opposed to being steered sideways.

(m) The transducers may be operated in a primary frequency or at one or more harmonics in any one of therapy-transmit or monitoring-reception modes. Their spectral bandwidth and spectrum details may be optimized for maximal coupling as learning continues. Their output may be optimized to produce beneficial harmonics in the tissue itself as is known to the ultrasound-imaging and ultrasound contrast-agent arts.

(n) Any one or more of the drugs employed in the practice of the present invention may also, or in addition, comprise antioxidants, vitamins, such as vitamins E and C, or any other medicament, minerals, vitamins, concoction or drug-cocktail administered in any convenient known manner which provides a medical benefit to the patient's condition. That is to say, the present inventive system is a platform for implementing newly-discovered drug therapies targeting the taught disease types. It is not meant to be restricted only to existing medications. In particular, we expect numerous new genetically engineered targeted drug therapies for Alzheimer's Disease.

### INDUSTRIAL APPLICABILITY

The system and methods disclosed and claimed herein is expected to find use in the treatment of Alzheimer's and related diseases.

Thus, there has been disclosed a system and methods for the treatment of Alzheimer's and other deposition-related disorders of the brain. It will be readily apparent to those skilled in this art that various changes and modifications of an obvious nature may be made, and all such changes and modifications are considered to fall within the scope of the present invention, as defined by the appended claims.

What is claimed is:

1. A system for the therapeutic treatment of abnormal protein-related or prion-related diseases of a human patient's brain or neurological system comprising:
(a) acoustic exposure therapy means comprising at least one acoustic or vibration emitter for acoustically or mechanically coupling, directly or indirectly, acoustic or vibratory emissions into a brain or neurological region which has been, is, or is expected to potentially be subject to the nucleation, growth or deposition of abnormal-protein or prion-related deposits, nodules or bodies;
(b) means for exciting said emitter to emit acoustic or vibration energy with a desired characteristic; and
(c) said emitter adapted to deliver therapeutic acoustic or vibration energy, directly or indirectly, to at least one of said brain or neurological regions, the therapy designed to provide, enable or accelerate at least one of the following therapy processes:
(i) physical breakup, breakdown, erosion, dispersion, disentanglement, de-aggregation, redistribution, dissolution, de-agglomeration, de-amalgamation or permeation of at least some said deposits, nodules or bodies,
(ii) interference in, slowing of, or reversal of at least one physical, chemical, biological or genetic deposit, nodule or body formation-process, formation-sequence or formation pathway anywhere in the process, sequence or pathway, and
(iii) aiding the recovery, growth, regrowth, new growth or improved chemical, physical, biological, genetic or cognitive functionality of brain-related or neurological-related cells, physiology or functional pathways negatively impacted or stressed by the deposition of, formation of, or presence of said deposits, nodules or bodies or their associated formation processes.

2. The system of claim 1 wherein said at least one emitter is located outside the body of said patient.

3. The system of claim 2 wherein said at least one emitter is located outside the skull of said patient.

4. The system of claim 3 wherein therapeutic acoustic or vibratory energy is directed or passed through or across at least a portion of the patient's blood-brain barrier or skull bone.

5. The system of claim 4 wherein at least some of said therapeutic acoustic or vibratory energy opens at least a portion of said blood-brain barrier, at least temporarily, for enhanced passage at least one of inwards or outwards, of medicaments, drugs, byproducts of the deposition therapy process itself or disease species.

6. The system of claim 4 wherein said therapeutic acoustic or vibratory energy is at least one of: (a) below the unaided cavitation threshold and therefore blood brain barrier opening via unaided cavitation mechanisms is largely avoided, (b) above the unaided cavitation threshold and therefore cavitation significantly aids the opening of the blood brain barrier, and (c) above a reduced energy level required to cavitate or excite an administered microbubble, microparticulate or other cavitation or excitation agent such that its vibrational motions significantly aids opening of the blood brain barrier.

7. The system of claim 1 wherein at least one said emitter is located inside the body of said patient.

8. The system of claim 7 wherein at least one said emitter is located inside the skull of said patient.

9. The system of claim 8 wherein said at least one emitter is located in a natural neurological lumen, cavity or passage adjacent to or within the brain or neurological system and said emitter is capable of emitting or directing therapeutic energy into a surrounding, adjacent or nearby brain or neurological region.

10. The system of claim 8 wherein said at least one emitter is located in or delivered into said skull via access through a craniotomy, other skull borehole or opening, via any natural body lumen, through the vascular system or through a natural interior space or cavity.

11. The system of claim 1 wherein said at least one emitter is operated at least a portion of the time with at least one operating characteristic selected from the group consisting of continuous wave operation (CW), pulsed wave operation (PW), single-pulse operation, shaped-pulse operation, multipulse operation, pulse-train operation, broadband operation, narrowband operation, chirped operation, multitone operation, multifrequency operation, having a harmonic frequency, having a pre-determined waveform, having controlled duty-cycle operation, having a predetermined frequency component or spectrum, having a fundamental or primary frequency, having a variable frequency, having a predetermined constant or variable amplitude, emitting a compressive and/or rarefaction wave, emitting a shear wave, or having a frequency useful for manipulating a microbubble, microparticle or contrast agent.

12. The system of claim 11 wherein output from said at least one emitter is at least one of focused, collimated, weakly focused, unfocused, diffused, diffuse, defocused, beamformed, steered or wiggled in any manner.

13. The system of claim 12 wherein formation of said output from at least one said emitter employs electronic phase-delays applied to subelements within one or more individual emitters such that at least one said emitter is a beamforming, beam-shaping or beam-steering multielement emitter.

14. The system of claim 12 wherein formation of said output from at least one said emitter employs mechanical shaping of an acoustic component of one or more individual emitters such that at least one said emitter utilizes a mechanically-shaped acoustic component for shaping acoustic emission from at least that emitter.

15. The system of claim 1 wherein multiple acoustic or vibration emitters are employed, at least some of said emitters temporally capable of at least one of individual, simultaneous, sequential, interleaved, overlapping, and phase-delayed operation relative to at least one other emitter.

16. The system of claim 15 wherein at least some said emitters are arranged in at least one of the following manners:
(a) at least one of said emitters is one of mechanically defocused, mechanically collimated, mechanically weakly focused, mechanically focused, or mechanically diffused or diffuse and said multiple emitters together allow for greater total brain-volume coverage or skull-area coverage than that offered by a single said emitter;
(b) the arrangement of (a) but wherein electronic phase-delay firing between at least two said emitters is also used for purposes of beam forming, steering, stewing or wiggling of emissions;
(c) the arrangement of (a) or (b) wherein phase delays are applied within at least one said emitter possessing at least two subelements such that at least one said emitter can internally provide some beam manipulation or slewing;
(d) at least one said emitter is mounted in or to a receptacle, hole or locating mechanism in or on a headpiece designed to hold or position at least one emitter;
(e) at least one said emitter can be attached to, mounted upon or located by said patient's headpiece in more than one possible position or angle relative to the skull;
(f) at least one said emitter is mounted in, on or located by said patient's headpiece in response to known brain or neural therapy target positions as determined by a brain or neural image; and
(g) at least one said emitter is acoustically coupled into a patient's brain or neurological region, with or without the aid of a headpiece or other emitter housing or locating means
(h) at least one said emitter is acoustically coupled into the skull or a therapy target region using an intermediate acoustically conductive film, gel, paste, cream or liquid.

17. The system of claim 1 wherein at least one said emitter incorporates, is thermally coupled to, or is thermally managed or monitored by a cooling means, temperature control means or temperature monitoring means which controls or monitors the temperature of (a) said at least one emitter or (b) any portion of a patient's anatomy or (c) the temperature or flow of a coolant, (d) the temperature of an acoustic couplant material juxtaposed to an emitter.

18. The system of claim 17 wherein at least one temperature of at least one portion of said patient's anatomy is monitored, deduced or projected and utilized in controlling, limiting, adjusting or setting a power delivery parameter of said system, manually or automatically.

19. The system of claim 1 wherein at least one said emitter is located inside the patient's skull, the emitter capable of emitting acoustic or vibration therapy energy into at least one selected adjacent or affected brain or neurological region, said emitter being at least one of: (a) an emitter which emits a fixed beam relative to itself, (b) an emitter which emits an electronically steerable beam, steerable relative to itself, and (c) an emitter which can have its beam mechanically steered or moved via physical movement of the emitter itself or of an interior portion thereof, (d) an emitter which emits a focused, weakly focused, collimated, defocused, unfocused diffused or diffuse emission pattern.

20. The system of claim 1 wherein the system is sufficiently portable that it may be operated in at least one of: (a) at a patient's home, (b) at a clinic, (c) at a nursing home, (d) at a doctor's office, (e) at an out-patient facility, (f) next to a chair or bed in which the patient resides, (g) at a chosen hospital bedside, and (h) in a manner allowing the patient to view or hear music, television or video content and thus be simultaneously entertained.

21. The system of claim 1 wherein said at least one brain or neurological region is chosen for a therapy exposure or session, or such an exposure or session is designed, planned or monitored with the help of at least one of the following:
(a) at least one radiological, diagnostic or functional image or graphic representation of said patient's brain, brain function, metabolism, neurology or neurological function or disease state;
(b) at least one statistical model or database based on a relevant patient or human population;
(c) at least one lab-test performed on said patient or on at least one patient's lab specimen, invasively or noninvasively; and
(d) at least one incidence of at least one of the above choosing, designing or monitoring methods taking place at least once before, during or after a therapy.

22. The system of claim 21 wherein said image or graphical representation is obtained using at least one of: positron-emission tomography (PET), single photon emission computed tomography (SPECT), functional positron emission tomography (fPET), magnetic resonance imaging (MRI), functional magnetic resonance imaging (fMRI), computed tomography (CT), computer aided tomography (CAT), X-Ray imaging, fluoroscopy, and ultrasound imaging (US) or using a spectroscopy technique based on one or more of these tools.

23. The system of claim 21 wherein said statistical model or database is one based on at least one of: (a) a database including living or deceased patients, (b) a database including genetic tendencies to acquire said disease or of genetic test results, (c) a database including risk factors for said disease, (d) a database including lab-test results, (e) a database including data from said patient, (f) one or more radiological, diagnostic or functional image of at least one patient, and (g) any patient record or report.

24. The system of claim 1 wherein a parameter of a given therapy session or a number of or parameter of further sessions to be undergone is determined, at least in part, by the use of at least one lab-test, or radiological, diagnostic or functional image or graphical representation which provides information relating to the current state, a recent state or an anticipated state of said disease in said patient.

25. The system of claim 24 wherein at least one said lab-test involves the taking or observing of a sample or portion of bodily fluid or bodily tissue and said sample is either non-invasively observed or is physically taken from the patient at least once, at least temporarily, before, during or after a therapy.

26. The system of claim 24 wherein at least one said lab-test involves the observation, recording or measurement of a property or state of the patient's spinal fluid, blood, urine, skin, tissues, other bodily fluid or physiological parameter and said lab-test is performed on said patient or on patient's sample at least once before, during or after a therapy invasively or noninvasively.

27. The system of claim 1 wherein said abnormal protein-related or prion-related disease affecting or expected to potentially affect the patient's brain or neurological system, directly or indirectly, is diagnosed to possibly, likely or certainly be one or more of: Guam-Parkinsonism dementia complex, Dementia Pugilistica, Parkinson's Disease, adult Down Syndrome, Subacute Sclerosing Panencephalitis, Pick's Disease, Corticobasal Degeneration, Progressive Supranuclear Palsy, Amyotrophic Lateral Sclerosis/Parkinsonism Dementia Complex, Hallervorden-Spatz Disease, Neurovisceral Lipid Storage Disease, Mediterranean Fever, Muckle-Wells Syndrome, Idiopathetic Myeloma, Amyloid Polyneuropathy, Amyloid Cardiomyopathy, Systemic Senile Amyloidosis, Hereditary Cerebral Hemorrhage with Amyloidosis, Alzheimer's Disease, Scrapie, Creutzfeldt-Jacob Disease, Fatal Familial Insomnia, Kuru, Gerstamnn-Straussler-Scheinker Syndrome, Medullary Carcinoma of the Thyroid, Isolated Atrial Amyloid, Beta2-Microglobulin, Amyloid in dialysis patients, Inclusion Body Myositis, Beta2-Amyloid deposits in muscle wasting disease, Islets of Langerhans Diabetes Type2 Insulinoma or the Polyglutamine diseases including Huntington's Disease, Kennedy's Disease, and all forms of Spinocerebellar Ataxia involving extended polyglutamine tracts.

28. The system of claim 27 wherein the disease is a form of Alzheimer's Disease and at least one type of plaque is being formed or is expected to form.

29. The system of claim 28 wherein a targeted plaque or plaque-forming process is related to at least one of senile plaque and fibril plaque formation contributing to a current or anticipated form of Alzheimer's disease.

30. The system of claim 1 wherein at least one of a drug, medicament, vitamin, mineral or controlled dietary matter or content is either (a) utilized in support of or in cooperation with at least one of said breakup, interference, and aiding such that the total overall therapy delivered over one or more therapy sessions incorporates the use of said drug, medicament, vitamin, mineral or dietary matter or content and the use of said acoustic or vibratory exposure therapy, with the drug, medicament, vitamin, mineral or controlled dietary matter or content and said acoustics or vibrations being used simultaneously, sequentially or both, or (b) employed, at least in part, to ameliorate the side effects of any acoustic or vibratory exposure itself.

31. The system of claim 30 wherein said at least one acoustic or vibratory therapy exposure, directly or indirectly, at least one of enhances, enables, accelerates, initiates or extends the action of said drug, medicament, vitamin, mineral or controlled dietary content in terms of treatment rate or completeness of the extent of treatment benefit.

32. The system of claim 31 wherein said enablement, enhancement, initiation, extension or acceleration is at least one of: (a) caused by the action of said acoustic or vibratory energy upon said at least one drug, medicament, vitamin, mineral or ingested controlled dietary matter or content and (b) caused by the action of said acoustic or vibratory energy on the anatomy, body tissue or body fluids of said patient, thereby favorably preparing said anatomy, tissue or body fluid for subsequent and/or simultaneous exposure to said at least one drug, medicament, vitamin, mineral or controlled dietary matter or content.

33. The system of claim 30 wherein said at least one drug, medicament, vitamin, mineral or controlled diet provides anti-inflammatory or anti-ischemic benefit.

34. The system of claim 30 wherein said at least one drug, medicament, vitamin, mineral or ingested dietary content, at least in part, reaches a brain or neurological region by passing through the blood-brain barrier (BBB), either unaided or in aided form, wherein said aid comprises one of:
(a) the use of said at least one form of a drug, medicament, vitamin, mineral or controlled dietary ingested content known to chemically open said BBB to itself or to the ingress of another therapeutic drug;
(b) the use of said acoustic or vibratory energy to open said BBB via cavitation, bubble oscillation, heating or any other mechanisms;
(c) the use of said acoustic energy to drive, transport or diffuse said at least one drug, vitamin, mineral or controlled dietary ingested content through said BBB without cavitation mechanisms predominating said driving; and
(d) the use of a combination of said at least one drug, vitamin, mineral or controlled dietary content opening said BBB and also itself delivering therapy to said brain or neurological regions of interest.

35. The system of claim 30 wherein the acoustic or vibratory exposure of at least some brain or neurological tissues accelerates, directly or indirectly, the perfusion, diffusion, transport, or physical, chemical or biological therapeutic action of said at least one said drug, medicament, vitamin, mineral or controlled ingested dietary matter or of a reactive species or product thereof.

36. The system of claim 30 wherein acoustic streaming, acoustic radiation-pressure or acoustic-cavitation developed in or near said brain or neurological region by said acoustic or vibratory exposure assists in transport, perfusion, diffusion, disbursement, delivery or distribution of said at least one drug, medicament, vitamin, mineral or controlled dietary ingested matter or of a subspecies, constituent or by-product thereof.

37. The system of claim 30 wherein said at least one drug, medicament, vitamin, mineral or controlled dietary matter comprises or includes at least a microbubble or microparticulate agent administered or ingested into the body, into the blood, into a tissue or bodily fluid or into a brain or neurological region, said agent providing for enhanced or reduced power-threshold cavitation or bubble oscillation when under acoustic or vibratory illumination, said enhanced cavitation or oscillation at least micromechanically and therapeutically contributing to at least one of said breakup, interference, and aiding therapy process.

38. The system of claim 37 wherein said microbubble or microparticulate also acts as a drug or medicament carrier or drug-bearing medium, at least one therapeutic drug or medicament emanating from said microbubbles or microparticles at some point after administration or ingestion into the body of said patient, said emanation taking place by natural leakage, diffusion or release of drug from said microparticles or by acoustically excited release, diffusion or leakage from said particulates.

39. The system of claim 30 wherein at least one drug, medicament, vitamin, mineral or controlled dietary matter supporting the therapy, directly or indirectly, includes at least one of: 4-hydroxynonenal, acetylcholinesterase or acetylcholine modulators, 1-amino-3,5-dimethyladamantane hydrochloride, acetyl-1-carnitine, alpha 2-macroglobulin drugs, alpha-synuclein or synuclein modifiers or modulators, antibodies, anti-coagulants, anti-inflammatories, anti-ischemics, anti-oxidants, anti-sense drugs, apolipoprotein or apolipoprotein-gene modifiers or modulators, apomorphine-based molecules, donepezil, aspirin, beta-secretase modifiers or modulators, biological reducing agents, celecoxib, 5-aminosalicyclic acid, chelation modulators or agents, cholesterol modulators, cholinergic drugs, coenzyme Q10, tacrinehydrochloride, cognition-enhancing drugs, cyclooxygenase-2 (COX-2) inhibitors, C-terminal tau inhibitors, diets controlling calories or fat, diets providing anti-oxidants, diets providing vitamins or minerals, domain ligands, donepezil, diazespam, drugs which affect protein kinase C pathways or tyrosine kinase pathways or phosphotyrosine pathways, drugs which affect copper or zinc binding to clioquinol, drugs which modulate aluminum, zinc, copper, iron, fluoride or calcium species, estrogen, drugs which affect APP protein or mutant APP, drugs which affect any one of APOE or APOEe4 or any APOE allele, drugs which affect presenilin protein or presenilin 1, drugs which affect a proteolysis function, drugs which affect tau genes or tau mutations, drugs which affect the behavior of chromosome 17, drugs which reduce oxidative damage, drugs which reduce oxidative damage to RNA, drugs which reduce free radicals, estrogen-like drugs or estrogen-like replacement therapies (ERTs), drugs which treat the cholinergic system, rivastigmine tartrate, folate or folic acid modulators, galantamine, gamma-secretase drugs, gene delivery drugs, genetically engineered drugs, Ginkgo Biloba, glutamate modulators, homocysteine modulators, hormones, Hydrochloride, hyperzine A, H₂O₂ modulators, ibuprofen, immunomodulating drugs, indomethacin, inflammatory cytokines, insulin degrading enzyme IDE, iron modulators or modifiers, ketone drugs, kinesin-1 modulators, leteprinim potassium, lithium, M-CSF or macrophage colony stimulating factor, memantine, mimetics, monoclonal antibodies, matrix metalloproteinase (MMP) modulators, leteprinim-potassium, neurotrophic factors, neural growth factors (NGFs), notch protein drugs, non-steroidal anti-inflammatories (NSAIDS), nitric oxide modulators, parkin gene modulators or modifiers, peptides, plasmins, PP1 enzyme blockers, prednisone, prodrugs, protease inhibitor gene drugs, protein-kinases, proteolytic antibodies, R-flurbiprofen, galantamine HBr, rivastigmine, serum nerve growth factor, rofecoxib, statins, stem-cells or stem-cell derived medicaments, steroids, tacrine, transplanted cells, transplanted cell constituents, transplanted genetic materials, transplanted body fluids or fluid constituents, triterpenoids, ubiquitin-C-hydrolase-L1, vaccines, rofecoxib, vitamins, Vitamin C, and Vitamin E, beta-amyloid modifiers or modulators, tau modifiers or modulators, vaccines, PYM50228, gamma-aminobutyric acid (GABA), GABA-like drugs, muscimol, benzodiazepines, Wnt, beta-catenin, HoxB4, and talsaclidine.

40. The system of claim 30 wherein the patient at least one of is administered, ingests or takes a drug, medicament or controlled dietary matter before, during or after at least one acoustic or vibratory exposure, the drug or medicament reaching a tissue to be treated, directly or indirectly, before, during or after an exposure to said acoustic or vibratory energy.

41. The system of claim 1 wherein at least one drug, medicament, vitamin, mineral or controlled dietary matter or content is used for at least one of: (a) to provide, enable, initiate, extend or accelerate at least one said breakup, interference, or aiding process and (b) to ameliorate a side-effect of said acoustic or vibratory exposure, and said at least one drug, medicament, vitamin, mineral or controlled dietary matter or content is administered, ingested, taken-in, therapeutically delivered, provided, prescribed or recommended to said patient.

42. The system of claim 41 wherein said administration or intake is via (a) oral ingestion by eating or drinking, (b) nasal or oral inhalation, (c) injection or introduction anywhere into the body of said patient, either percutaneously, transdermally or via a natural orifice (d) metered or controlled release from outside or inside the body of said patient, (e) via a skin-patch, (f) via a catheter or port, or (g) via the delivery of genetic or cellular materials from outside the body.

43. The system of claim 41 wherein said administration, provision or intake is via metering or controlled release from a pump, injector or other flow, flow-direction, or pressure-controlled source located anywhere outside or inside the body of said patient.

44. The system of claim 1 wherein said acoustic or vibratory exposure provides, initiates, extends, enables or accelerates to a useful degree the rate or extent of at least one said breakup, interference or aiding process via mainly acoustic-driven mechanisms without the required use of medicaments, vitamins, minerals or controlled dietary ingested matter for said providing, enabling or acceleration.

45. The system of claim 1 wherein at least one said acoustic or vibratory exposure is arranged or chosen to utilize at least one acoustic or vibratory wavelength which bears a calculatable or histological relationship to a characteristic dimension of a plaque, fibril or prion-related deposit or defect, said choosing causing a desirable mechanical interaction between said plaque, fibril, nodule or defect and said acoustic or vibratory waves, thereby micromechanically contributing to at least one of said breakup, interference, and aiding processes.

46. The system of claim 45 wherein said characteristic dimension is approximately that of a representative fibril, nodule, defect or deposit dimension.

47. The system of claim 1 wherein a cooling or heat-exchange means is provided which is in thermal communication with at least one of: (a) an emitter, (b) any of the anatomy of said patient, and (c) the skull of said patient, and heat flows directly or indirectly either to or from said cooling or heat-exchange means to or from at least one of an emitter, a patient's anatomy or a patient's skull.

48. The system of claim 47 wherein the cooling or heat-exchange means provides for: (a) controlling or limiting the temperature of said at least one emitter, directly or indirectly, (b) controlling or limiting the temperature of at least a portion of said patient's anatomy or of the skull of said patient, directly or indirectly, or (c) the use of higher acoustic powers than would otherwise be possible without use of said cooling or heat-exchange means, while maintaining safe maximum patient temperatures.

49. The system of claim 1 further including at least one of: (a) a cooling or heat-exchange means for transferring heat to or from said at least one emitter, from a portion of the patient's anatomy, or from the skull of said patient and the operation of said cooling or heat-exchange means is in response or in support of the operation of said at least one emitter or to temperatures caused thereby in the skull or anatomy, and (b) a drug, medicament, vitamin or mineral delivery means providing a drug, medicament, vitamin or mineral in support of at least one of said breakup, interference, and aiding therapy processes, said drug, medicament, vitamin or mineral delivered to said patient responsive to at least one of a flow control, a pressure control, a dosage control, a blood-concentration control, a sensor, a software or firmware program, a system control setting, a sensor, a timer, a real-time or individual-use lab-test or test-sampling, and a practitioner's direction.

50. The system of claim 1 wherein at least one emitter's output is mechanically scanned relative to said patient's brain, either by patient movement, system movement, emitter movement or emitter relocation on the headgear or a combination thereof.

51. The system of claim 1 further including a removable helmet, head-band or other juxtaposed or head-attached structure for securement to or juxtaposition to the head of said patient, said helmet or structure incorporating or providing mounting, locating or positioning means for at least one said emitter, said helmet/structure or emitter(s) therein or thereon becoming acoustically coupled to the patient, said coupling being achieved into or through the patient's scalp or skull thereby allowing delivery of acoustics into the patient.

52. The system of claim 51 wherein said patient's head is at least partially in, enclosed by or surrounded by a helmet, head-band or head-attachment structure containing, supporting, locating or positioning at least one said emitter, said structure being at least partially supported by said system yet also being mounted to or at least placed near or on the patient's head in order to perform said therapy.

53. The system of claim 51 wherein the patient's head is in a helmet, headband or head-attachment structure containing or having attached thereto or thereon at least one said emitter, said structure having one or more of an umbilical, cable or coolant lumen which connects or is connectable to said system.

54. The system of claim 1 further including acoustic coupling means for coupling output from said at least one emitter directly or indirectly into a tissue or body fluid of said brain or neurological system, said acoustic coupling means utilizing at least one of (a) an interposed liquid, gel, paste, cream, emulsion or acoustic-standoff, (b) an interposed inflatable fillable or soakable bag, membrane or sponge material, (c) an interposed acoustically water-like material.

55. The system of claim 54 wherein said acoustic coupling means also provides some skull size or shape adaptability for various-sized or shaped patient's heads for a given patient or from patient to patient.

56. The system of claim 1 wherein operational set-up or compensation is made for at least one of the following variables or changes: (a) variable skull thickness or shape from location to location on a given skull, or variable skull thickness or shape from patient-to-patient, (b) a variable skull, scalp or emitter temperature from location to location or at a single location over time, (c) a change in a relevant or representative brain or neurological temperature, (d) a change in a local or a nearby temperature in a general region of diseased or treated brain or neurological tissue, (e) a change in the result of an invasive or noninvasive lab-test monitoring a variable related to a state of the disease or to a state of a plaque-burden, (f) a change in a metabolic or physliological instrument reading or patient-monitor, (g) a change in the patient's comfort level, (h) a change or variation in the acoustic velocity, attenuation or dimension of a patient's skull, skin, brain or neurological tissue or plaque, (i) a change or variation in detected brain-tissue perfusion or in cerebral lumen blood-flow, (j) a change in the cavitation or oscillation behavior of a microbubble or microparticulate, (k) a change in an actual or desired concentration or of a delivery parameter of a drug, (l) a change in an actual or desired acoustic power to be delivered, (m) a change in the actual or desired concentration of a species of interest in a blood, urine, skin or spinal fluid test or ongoing sampling, and (n) a change in a brain radiological or functional image or graphical representation, (o) a change in the amount of, nature of or presence of undesired side-effects being experienced or detected or anticipated., (p) a change in blood pressure or cerecrospinal fluid pressure, (q) a change in a state of inflammation whether due to the disease or the acoustics themselves, (r) a change in any brain function, (s) changes in locations or concentrations of plaque, fibrils or nodules within a single patient over time or from patient to patient, and (t) direction provided by software, firmware or by an operator or overseer of the system, regardless of whether any one of these is locally or remotely located.

57. The system of claim 1 wherein acoustic or vibratory energy is also utilized to diagnostically probe or measure a characteristic of the brain, skull, neurological system, disease state, physiology or temperature of said patient or operation of an emitter, the characteristic useful to set up, control or insure safe or efficient operation of said system.

58. The system of claim 1 wherein said at least one acoustic or vibratory emitter comprises an ultrasonic, acoustic or vibratory element which is electrically, electrostatically, magnetically, magnetostrictively, electromagnetically or optically driven or wherein said emitter is an outport port on an acoustic waveguide.

59. The system of claim 1 wherein said at least one acoustic or vibration emitter is coupled, directly or indirectly, into said patient's brain or neurological system through at least one of an upper or lower jaw, neck or spine of said patient.

60. The system of claim 1 wherein said acoustic or vibratory coupling means includes:
(a) a shaved head or a head with reduced hair quantity;
(b) wetted hair using any hair-wetting material or a wetted scalp using any scalp-wetting material;
(c) wetted or gell-coated emitter or emitter portions;
(d) inflated or filled expandable acoustically-conductive bags, membranes or standoffs;
(e) provision of a saturatable or soakable material which acts as an acoustically transparent standoff or coupler in the soaked state;
(f) provision of a flexible or stretchable acoustically-transparent skullcap which is wettable or which promotes acoustically coupling on at least one inner or outer surface;
(g) provision of a flexible or stretchable skullcap which serves to control the patient's hair;
(h) flow or placement of an acoustically conductive liquid in an emitter/skull interface region;
(i) flow or placement of an acoustically conductive coolant or other heat transfer media in an emitter/skull interface region; and
(j) flow or placement of an acoustically conductive gel or paste in an emitter/skull interface region.

61. The system of claim 1 wherein at least a portion of one said deposit, nodule or body undergoes at least one of shear, compressional or tensile-distortion or stress or is excited into a vibratory mode by an acoustic or vibratory emission having a wavelength chosen to bear a relationship to a characteristic dimension of at least one said deposit, nodule or body, the distortion, stress or vibratory behavior favorably contributing to at least one of said therapeutic breakup, interference, and aiding process.

62. The system of claim 1 wherein said deposits, nodules or bodies are, at least in part, one of spatially distributed, diffusely distributed, aggregated, agglomerated, intracellularly situated, extracellularly situated, fibril-like, plaque-like, have a microscopic sheet structure or are directly or indirectly associated with cognitive losses.

63. The system of claim 1 wherein at least said aiding process is practiced in order to at least eventually achieve at least one of: (a) enhanced perfusion, diffusion, transport or distribution of blood or cerebrospinal fluid or fluid constituents including disease species, (b) enhanced perfusion, diffusion, transport or distribution of a drug or medicament, (c) enhanced perfusion, diffusion, transport or distribution of a functional signaling chemical or species, (d) enhanced cognitive function, (e) enhanced transport of a plaque, prion or deposit breakdown product or related debris, (f) enhanced perfusion, diffusion, transport or distribution of a medicament incorporating stem cells, living cells, or byproducts or derivatives of cells, whether natural cells or genetically manipulated cells, and (g) dead or living cells or cell constituents or derivatives serving as a vaccine

64. The system of claim 1 wherein at least one of: (a) said acoustic or vibratory exposure contributes to enhanced cognitive function or a decrease in the rate of cognitive loss, and (b) said acoustic or vibratory exposure combined with the sequential or simultaneous use of a drug, medicament or controlled dietary intake both contribute in at least some manner to enhanced cognitive function or a decrease in the rate of cognitive loss, regardless of whether said acoustic or vibratory energy provides, enables or accelerates the action of the drug, medicament or dietary content.

65. The system of claim 64 wherein said acoustic or vibratory energy provides, enables, accelerates or initiates a beneficial action of at least one said drug, medicament or dietary content, either directly or indirectly.

66. The system of claim 1 wherein said aiding includes causing the concentration or activity of a chemical, genetic, cellular or biological material, reactant, product or byproduct which plays a damaging role or is involved in the damage sequence or chain of events of the neurodegenerative disease is at least partly reduced, partly inactivated, chemically tied up or rendered inactive such that the rate of neurodamage is slowed or stopped.

67. The system of claim 66 wherein said activity or concentration is reduced, tied up or made inactive accompanied by its ultimate removal from the body with the help of a natural body process including at least one of: (a) brain metabolism, (b) brain perfusion or circulation of blood, (c) cerebrospinal fluid production or circulation, and (d) body excretion as waste.

68. The system of claim 67 wherein said acoustic or vibratory exposure facilitates or accelerates said subsequent removal in any manner.

69. The system of claim 1 wherein the patient at least one of:
(a) receives an initial lab-test, imaging session, diagnostic session or other exam or test in order to stage the disease or to understand the disease potential;
(b) receives one or more of any one or more of said breakup, interference or aiding therapies over a period of one or more sessions;
(c) receives a combination of at least two of said breakup, interference or aiding therapies over a period of one or more sessions;
(d) receives at least one each of said breakup, interference, and aiding therapy in at least one session;
(e) receives at least one each of said breakup, interference, and aiding therapy over a period of two or more sessions;
(f) has a body fluid or tissue sample taken before, during or after at least one therapy session;
(g) has a body fluid or tissue analyzed or monitored invasively or noninvasively, before, during or after at least one therapy session; and
(h) undergoes functional imaging or cognitive testing.

70. The system of claim 1 wherein cooling or heat-exchange is employed to maintain, limit or control a temperature related to the patient's anatomy or to the therapy delivery means, regardless of whether the system is aware of the actual temperature present.

71. The system of claim 1 wherein a wired, wireless, digital, analog, telephony, data, fiberoptic, video or network connection allows for interaction with the therapy system or patient from a distance or from a remote location.

72. The system of claim 1 wherein: (a) multiple emitters are employed, each primarily treating at least some unique emitter-assigned brain or neurological system region or subregion, (b) multiple emitters are employed and there is a significant overlap in the treated or treatable regions or subregions addressable by said emitters, (c) multiple emitters are employed in any manner and operated sequentially, (d) multiple emitters are employed in any manner and operated simultaneously, (e) multiple emitters are employed in any manner and at least two are operated with controlled phase angle delays relative to each other, (f) at least one emitter comprises multiple acoustic subelements, (g) at least one emitter steers or shapes emissions, at least in part, using a mechanically shaped acoustic component, (h) at least one emitter is moved among at least two different possible mountable positions or angles over a period of one or more therapies, (i) at least one emitter mates with electrical or coolant connectors predisposed in the helmet or headgear, (j) at least one emitter structure also serves to form the structure of the helmet itself, (k) the helmet or headgear or emitter housing or holder is, at least in part, directly made from material which is capable of emitting or receiving acoustic energy, (l) the helmet or headgear is mechanically mated to the patient during operation, (m) the patient rests or places his/her head juxtaposed against or to a pillow-like entity which holds an emitter, (n) the headgear, helmet or pillow structure holding at least one emitter also incorporates a thermal control means during operation, (o) an emitter is chosen for its frequency or penetration ability, (p) an emitter is chosen for its fit to the helmet or to the patient, (q) the patient sits, reclines or lies down during the therapy, (r) the patient is entertained with audio and/or video content during the therapy, (s) the patient undergoes therapy using a portable or semiportable system, (t) the patient undergoes therapy at home, at a clinic, at a doctor's office, at an outpatient office, at a hospital or at a nursing home, (u) the patient intakes a drug, medicament, controlled dietary content or therapeutic genetic or cellular substance before, during or after at least one therapy session, both the emissions and the drug contributing individually or cooperatively, to therapeutic benefit, (v) comfort or adjustability is provided by an intervening acoustic standoff which is shapable, the emitters passing their emissions through said standoff, the shapability adaptable to the patient's head, (w) a shapable acoustic standoff serves as a conforming pillow for patient comfort or for improved acoustic coupling, (x) a patient acoustic coupling means incorporates a thermal control feature, or (y) an emitter itself incorporates a connector or a thermal control means.

73. The system of claim 1 wherein said acoustic or vibratory exposure is of intensities or powers which allow for prolonged exposure or multiple exposures of said patient's brain or neurological system without accumulating unacceptable acoustically-induced permanent damage to neurologically significant portions of the patient's anatomy, tissues or fluids.

74. The system of claim 1 wherein said acoustic or vibratory exposure is of intensities or powers such that the accumulated time at temperature of treated brain regions is below that which would cause significant permanent thermal damage to healthy cells.

75. The system of claim 1 wherein said ultrasonic power per unit area is between 5 milliwatts per square centimeter and 10 watts per square centimeter.

76. The system of claim 75 wherein at least one of:
(a) at least one frequency between 1 hertz and 2 megahertz is employed with or without cooling or heat-exchange;
(b) at least one frequency of between 2 megahertz and 5 megahertz is employed with cooling or heat-exchange;
(c) the temperature rise in a portion of the patient's tissue or bodily fluid is limited to 5 degrees centigrade or less.
(d) the duty cycle of the acoustic power is set between 10 and 25% on-time; and
(e) and healthy tissues are spared permanent unacceptable thermal or acoustic damage.

77. The system of claim 1 wherein said at least one acoustic emitter is inside the skull of said patient or in an interior location of said patient's brain or neurological system and said acoustic or vibratory energy emanates in at least one direction generally outward toward a patient's scalp or toward a skinline.

78. The system of claim 1 wherein any beam-forming or beam-steering is done at least for the purpose of achieving increased or more uniform coverage of targeted or targetable brain or neurological regions.

79. The system of claim 1 wherein said disease is, at least in part, resident in any of the following brain or neurological tissues: hippocampus, entorhinal cortex, cerebral cortex, posterior cingulated cortex, neocortex, allocortical regions, basal forebrain, or cerebellar tissues.

80. The system of claim 1 wherein said acoustic or vibratory energy is capable of providing, enabling, accelerating or initiating said breakup, interference or aiding process, said acoustic or vibratory therapy process itself not requiring a drug, medicament or controlled dietary content to proceed at a useful pace or to a useful extent.

81. The system of claim 1 wherein a drug, medicament or controlled dietary content is used to comfort the patient or to relieve existing or potential side-effects of said acoustic or vibratory exposure, regardless of whether it contributes to the therapy itself

82. The system of claim 80 wherein said breakup, interference or aiding process enhances patient cognition at least after some time has passed.

83. The system of claim 1 wherein cognition loss is at least slowed, stopped or reversed at least after some time has passed.

84. The system of claim 1 wherein the primary physical components of said system include a console or control box, a headpiece incorporating at least one said emitter, and at least one connecting or connectable cable or lumen connecting said console and said headpiece.

85. The system of claim 1 wherein a bodily fluid such as blood or cerebrospinal fluid is manipulated in any manner in cooperation with at least one said acoustic or vibratory exposure or by said exposure, the combined exposure and manipulation having at least one of additive, extending or acceleration-of-therapy effects.

86. A method for the therapeutic treatment of abnormal protein-related or prion-related diseases of a human patient's brain or neurological system comprising:
(a) acoustically coupling said patient's brain or neurological system to acoustic therapy means comprising at least one acoustic or vibration emitter for acoustically or mechanically coupling, directly or indirectly, acoustic or vibratory emissions into a brain or neurological region which has been, is, or is expected to potentially be subject to the nucleation, growth or deposition of abnormal-protein or prion-related deposits, nodules or bodies;
(b) exciting said emitter to emit acoustic or vibration energy with a desired characteristic; and
(c) delivering therapeutic acoustic or vibration energy from said emitter, directly or indirectly, to at least one said brain or neurological region, the therapy designed to provide, enable, accelerate or initiate at least one of the following therapy processes:
(i) physical breakup, breakdown, erosion, dispersion, disentanglement, de-aggregation, redistribution, dissolution, de-agglomeration, deamalgamation or permeation of at least some said deposits, nodules or bodies,
(ii) interference in, slowing of, or reversal of at least one physical, chemical, biological or genetic deposit, nodule or body formation-process, formation-sequence or formation pathway anywhere in the process, sequence or pathway, and
(iii) aiding the recovery, growth, regrowth, new growth or improved chemical, physical, biological, genetic or cognitive functionality of brain-related or neurological-related cells, physiology or functional pathways negatively impacted or stressed by the deposition of, formation of, or presence of said deposits, nodules or bodies or their associated formation processes.

87. The method of claim 86 wherein a drug, medicament or controlled dietary content optionally being administered enhances therapy effectiveness or comfort, independently or in cooperation with the emitted energy.

88. A system for the therapeutic treatment of abnormal protein-related or prion-related diseases of a human patient's brain or neurological system comprising:
(a) means to direct acoustic or vibrational energy into or through at least one such diseased or potentially diseased anatomy portion; and
(b) an optional drug, medicament or controlled dietary content capable of contributing to the therapy also directly or indirectly delivered to the portion, wherein the acoustics and optional drug together at least slow a cognitive loss process by slowing, stopping or reversing a deposition process.

89. The system of claim 88 wherein the drug, medicament or dietary content is at least one of: (a) known to provide useful therapy even without the acoustic emissions present, and (b) requires acoustic emissions to directly or indirectly cause the drug to be of therapeutic benefit

90. The system of claim 88 wherein the drug, medicament or dietary content has its therapeutic contribution enabled, enhanced, initiated, accelerated or extended due to an effect, latent effect or side-effect of at least one acoustic exposure

91. The system of claim 88 wherein the acoustic emissions are unfocused, weakly focused, diffused, diffuse, collimated or overlapping spatially or temporally

92. The system of claim 88 wherein the drug also serves as an imaging contrast agent or serves to minimize an undesirable side-effect of the acoustic exposure

93. The system of claim 88 wherein acoustic measurements or imaging is practiced in support of the therapy, regardless of whether any of the therapy emitters are also used for said measurements or imaging

94. The system of claim 88 wherein blood or cerebrospinal fluid is otherwise manipulated in cooperation with the emission therapy, said manipulation comprising at least temporary shunting of blood or cerebrospinal fluid

95. A method of at least temporarily slowing, stopping or avoiding a patient's cognitive losses associated with a neural deposition disease comprising administration of acoustic or vibrational energy into affected or potentially affected patient anatomy portions, said energy altering, blocking or reversing a cognitively-damaging deposition process, at least temporarily.

96. A system for at least temporarily slowing, stopping or avoiding a patient's cognitive losses associated with a neural deposition disease comprising administration of acoustic or vibrational energy controllably emitted from an acoustic emitter into affected or potentially affected patient anatomy portions, said energy altering, blocking or reversing a cognitively-damaging deposition process, at least temporarily.
